(19) United States
(12) Patent Application Publication
(10) Pub. No.: US 2026/0163245 A1
(43) Pub. Date: Jun. 11, 2026

(54) FREQUENCY SELECTIVE SURFACE STRUCTURE, ANTENNA SYSTEM, AND BASE STATION

(71) Applicant: HUAWEI TECHNOLOGIES CO., LTD., Shenzhen (CN)

(72) Inventors: Haiqiang Sheng, Shanghai (CN); Guoyu Su, Shenzhen (CN); Weihong Xiao, Dongguan (CN); Wenfei Qin, Shanghai (CN); Jinsong Lv, Shanghai (CN)

(73) Assignee: HUAWEI TECHNOLOGIES CO., LTD., Shenzhen (CN)

(21) Appl. No.: 19/463,714

(22) Filed: Jan. 29, 2026

Related U.S. Application Data
(63) Continuation of application No. PCT/CN2024/078579, filed on Feb. 26, 2024.

(30) Foreign Application Priority Data
Jul. 31, 2023 (CN) 202310962161.8

(51) Int. Cl. H01Q 15/00; H01Q 3/36; H01Q 21/06

(52) U.S. Cl. CPC H01Q 15/0013; H01Q 3/36; H01Q 21/065

(57) ABSTRACT

This disclosure provides a frequency selective surface structure, an antenna system, and a base station. The frequency selective surface structure includes a frequency selective surface, a feeding network, and a phase shifter. The frequency selective surface includes a metal layer, the phase shifter is electrically connected to the feeding network, and the phase shifter and the feeding network are integrated into the metal layer of the frequency selective surface. The frequency selective surface structure can further reduce a transmission loss caused to avoid blocking of an antenna beam by the phase shifter, and can balance a coverage area and transmission quality of an antenna signal, thereby resolving a problem that it is difficult to arrange a phase shifter in a multi-band integrated antenna system.

### CROSS-REFERENCE TO RELATED APPLICATIONS

This application is a continuation of International Application No. PCT/CN2024/078579, filed on Feb. 26, 2024, which claims priority to Chinese Patent Application No. 202310962161.8, filed on Jul. 31, 2023. The disclosures of the aforementioned applications are hereby incorporated by reference in their entireties.

### TECHNICAL FIELD

This disclosure relates to the field of communication technologies, and in particular, to a frequency selective surface structure, an antenna system, and a base station.

### BACKGROUND

A base station antenna is the basis of current mobile communication and plays an important role in mobile communication. A communication system of higher-rate and larger-capacity than the current systems is desired, for meeting the increasing mobile communication rates and bandwidth requirements. A base station antenna system is evolving from a 4th generation (4G) mobile communication technology to a 5th generation (5G) mobile communication technology. A current key technology is to provide a multi-band integrated antenna system for an operator.

In an existing multi-band integrated antenna system, antennas on a plurality of bands are stacked, and a corresponding feeding network is disposed for each layer of antenna. Because a plurality of antennas in the antenna system are stacked, signals between the antennas on the bands interfere with each other, and consequently, an antenna radiation pattern is distorted. Structures such as a phase shifter and a frequency selective surface are usually disposed in the multi-band integrated antenna system, to reduce mutual impact between antennas on different bands and obtain a required antenna waveform. Flexible beam scanning is implemented by changing a band-pass characteristic, a band-stop characteristic, phase modulation, and the like of the feeding network, to reduce a coupling effect between the antennas on the different bands, thereby obtaining an ideal antenna waveform, increasing a coverage area of a base station antenna, and adapting to mounting and layout requirements in a plurality of scenarios.

However, when antenna layout density is high, layout of the phase shifter becomes a difficult problem. Because the phase shifter may be connected to the feeding network of the antenna, when the plurality of antennas are stacked, a part of phase shifters need to be arranged between the stacked antennas along with the feeding network of the antenna. The phase shifter has a size, and therefore, blocks beams of a part of antennas, affecting a coverage area of an antenna signal. Consequently, a user directly feels a too slow network speed or a signal coverage hole is generated in a part of areas.

To prevent the phase shifter from blocking the antenna waveform, some operators improve layout of the antenna system and the phase shifter, by using methods like separate layout or the like to stagger the phase shifter and an affected antenna. This method can mitigate, to some extent, a phenomenon that the phase shifter blocks the antenna waveform, but lead to drawbacks such as increased antenna size, less compact layout. Consequently, a transmission line structure between the phase shifter and a radiator of the antenna system is extended, resulting in a higher loss due to long-distance transmission.

Therefore, in the conventional technology, it is difficult to arrange a phase shifter of a multi-band integrated antenna system, a high transmission loss is caused to avoid blocking of an antenna beam by the phase shifter, and a coverage area and transmission quality of an antenna signal cannot be balanced.

### SUMMARY

Embodiments of this disclosure provide a frequency selective surface structure, an antenna system, and a base station, to resolve a problem in the conventional technology that it is difficult to arrange a phase shifter in a multi-band integrated antenna system, a high transmission loss is caused to avoid blocking of an antenna beam by the phase shifter, and a coverage area and transmission quality of an antenna signal cannot be balanced.

An embodiment of this disclosure provides a frequency selective surface structure, including a frequency selective surface, a feeding network, and a phase shifter. The frequency selective surface includes a metal layer, the phase shifter is electrically connected to the feeding network, and the phase shifter and the feeding network are integrated into the metal layer of the frequency selective surface.

The frequency selective surface structure provided in this embodiment of this disclosure can be applied to an antenna system, and both the phase shifter and the feeding network are integrated into the metal layer of the frequency selective surface. The metal layer of the frequency selective surface has a spatial filter characteristic, and a wave transmission characteristic of an antenna is changed by designing the metal layer, to meet a requirement for transmitting and adjusting and controlling of an electromagnetic wave of the antenna. The frequency selective surface may be designed to completely transmit a part of antennas, that is, to be of a structure electromagnetically transparent to the part of antennas. The phase shifter and the feeding network are integrated into the metal layer. The metal layer hides the phase shifter. If a miniaturized phase shifter is used, the phase shifter may be completely hidden on one side of the metal layer. In addition, the metal layer also hides a transmission line structure in the feeding network. The feeding network and the phase shifter do not affect a filtering characteristic of the frequency selective surface structure. In this way, the frequency selective surface structure jointly including the frequency selective surface, the phase shifter, and the feeding network can still be electromagnetically transparent to the part of antennas. Therefore, beams of the part of antennas are not blocked. The other part of antennas may be disposed on the other side of the frequency selective surface structure. In this way, electromagnetic waves of the other part of antennas are radiated in a direction away from the frequency selective surface structure, and the phase shifter does not block beams of the other part of antennas. Further, because the phase shifter and the feeding network are integrated together, a structure is compact, a length of the transmission line structure in the feeding network may be shortened, and a transmission loss is reduced.

Therefore, the frequency selective surface structure provided in this disclosure can further reduce the transmission loss caused to avoid blocking of an antenna beam by the phase shifter, and can balance a coverage area and transmission quality of an antenna signal, thereby resolving a problem that it is difficult to arrange a phase shifter in a multi-band integrated antenna system.

In some embodiments, the metal layer has a metal area, a hollow area is enclosed in the metal area, the feeding network and the phase shifter are integrated into the metal area, a projection of the feeding network and the phase shifter onto the metal layer along a first direction is entirely located in the metal area, and the first direction is perpendicular to a plane on which the metal layer is located.

According to the foregoing solution, the phase shifter and the feeding network are integrated into the metal area, and are carried in the metal area. The phase shifter and the feeding network are not stacked with the hollow area along the first direction, to prevent the phase shifter and the feeding network from blocking the antenna beam.

In some embodiments, the metal layer includes a metal grille, the metal grille forms the metal area, and space enclosed by the grids of the metal grille jointly forms the hollow area. The frequency selective surface of a grille shape has a regular shape and easy to process, and it is easy to perform wiring on a grid line in the metal grille.

In some embodiments, the metal layer includes a metal grille and a plurality of metal patches, the plurality of metal patches are correspondingly disposed in a plurality of grids of the metal grille, the metal grille and the metal patch form the metal area, and a gap between the metal patch and the metal grille forms the hollow area. The frequency selective surface of a grille shape has a regular shape and easy to process, and it is easy to perform wiring on a grid line in the metal grille. The feeding network and the phase shifter may also be arranged on the metal patch.

In some embodiments, the frequency selective surface includes a plurality of metal layers that are stacked in the first direction and that are disposed in parallel with each other, the feeding network and the phase shifter are integrated into at least one of the plurality of metal layers, and the first direction is perpendicular to the plane on which the metal layer is located.

In some embodiments, the plurality of metal layers include two metal layers, each of the two metal layers includes two surfaces facing away from each other in the first direction, and the feeding network and the phase shifter are integrated on any one or more surfaces of the two metal layers.

In some embodiments, the feeding network includes a plurality of transmission line structures; and the frequency selective surface structure includes one phase shifter, and the phase shifter is electrically connected to the plurality of transmission line structures; or the frequency selective surface structure includes a plurality of phase shifters, and each of the plurality of phase shifters is electrically connected to a part of the plurality of transmission line structures.

In some embodiments, the phase shifter includes an external conductor, a fixed dielectric, a sliding dielectric, and at least one signal-line winding, an accommodation cavity is formed in the external conductor, and the fixed dielectric, the sliding dielectric, and the at least one signal-line winding are accommodated in the accommodation cavity; the fixed dielectric is fastened to the external conductor, the sliding dielectric is located between the fixed dielectric and the external conductor and is slidably connected to the fixed dielectric, each of the at least one signal-line winding is wound around and fastened to the fixed dielectric, each signal-line winding is located between the fixed dielectric and the sliding dielectric, and the phase shifter is electrically connected to the feeding network through each signal-line winding; and at least a part of the external conductor is set to be of a planar structure, and the phase shifter is fastened to the metal layer through the planar structure.

According to the foregoing solution, the signal-line winding is fastened to the fixed dielectric, and the sliding dielectric covers a surface of the signal-line winding, and may slide on the surface of the signal-line winding. Changing a position of the sliding dielectric may change a range that is of each signal-line winding and that is covered by the sliding dielectric. A part that is of the signal-line winding and that is not covered by the sliding dielectric is exposed to air. An electrical length of the signal-line winding changes, thereby changing a phase shift amount of a radiator corresponding to each signal-line winding.

In some embodiments, the at least one signal-line winding is a plurality of signal-line windings, the plurality of signal-line windings form at least one group of signal-line windings, and each of the at least one group of signal-line windings includes at least one signal-line winding; and the at least one signal-line winding in each group of signal-line windings is one signal-line winding or at least two signal-line windings, one terminal of the one signal-line winding forms one input terminal of the phase shifter or the at least two signal-line windings are connected at one terminal to form one input terminal of the phase shifter, the other terminal of the at least one signal-line winding forms at least one output terminal of the phase shifter, and each of the at least one output terminal is electrically connected to a corresponding transmission line structure. One phase shifter may perform phase modulation on a plurality of radiators.

In some embodiments, the plurality of transmission line structures include at least one first transmission line structure, each of the at least one first transmission line structure includes an external conductor and a core, the core is wrapped in a cavity inside the external conductor, and there is an airgap between the core and the external conductor; and
at least a part of the external conductor is set to be of a planar structure, and the first transmission line structure is fastened to the metal layer through the planar structure.

According to the foregoing solution, a medium between the external conductor and the core is air. The core is entirely suspended in the cavity of the external conductor, and the core is surrounded by air in the cavity. A dielectric constant of the air is small, so that a transmission loss of the first transmission line structure can be reduced.

In some embodiments, the first transmission line structure further includes a plurality of support members disposed between the external conductor and the core, the plurality of support members are spaced apart along an extension direction of the core, and the core is fastened to the external conductor through the plurality of support members.

In some embodiments, the first transmission line structure includes a plurality of cores spaced apart; and the external conductor has one cavity, and the plurality of cores are located in the cavity; or the external conductor has a plurality of cavities that communicate with each other, the plurality of cavities are in one-to-one correspondence with the plurality of cores, and each core is located in a corresponding cavity.

In some embodiments, the plurality of transmission line structures include at least one second transmission line structure, each of the at least one second transmission line structure is configured as a power divider, the power divider includes a conductive housing and an electrochemical cell, the electrochemical cell is wrapped in a cavity inside the conductive housing, there is an airgap between the electrochemical cell and the conductive housing, the electrochemical cell has one input terminal and a plurality of output terminals, and the input terminal of the electrochemical cell is electrically connected to the phase shifter; and
at least a part of the conductive housing is set to be of a planar structure, and the second transmission line structure is fastened to the metal layer through the planar structure.

According to the foregoing solution, the electrochemical cell is suspended in the conductive housing and surrounded by air, to reduce a transmission loss of the power divider.

In some embodiments, when the phase shifter includes an external conductor, the external conductor of the phase shifter is electrically connected to the metal layer; when the feeding network includes the plurality of transmission line structures, the plurality of transmission line structures include the at least one first transmission line structure, and each of the at least one first transmission line structure includes the external conductor, the external conductor of each first transmission line structure is electrically connected to the metal layer; when the feeding network includes the plurality of transmission line structures, the plurality of transmission line structures include the at least one second transmission line structure, and each of the at least one second transmission line structure includes the conductive housing, the conductive housing of each second transmission line structure is electrically connected to the metal layer; and
an electrical connection manner is any one of the following: a coupling connection, a direct-current connection, or a segmented direct-current connection.

In some embodiments, the frequency selective surface structure further includes a dielectric layer, and the metal layer is mounted at the dielectric layer. The dielectric layer may be configured to support the metal layer.

An embodiment of this disclosure further provides an antenna system, including a ground, a plurality of antennas that are stacked in a first direction, and a plurality of feeding networks configured to feed the plurality of antennas. The ground is disposed on one side of the plurality of antennas in the first direction, the antenna system further includes the frequency selective surface structure according to any one of the foregoing embodiments, the frequency selective surface structure is disposed between adjacent antennas that are stacked in the plurality of antennas, and the feeding network of the frequency selective surface structure forms a feeding network of at least one antenna away from the ground in the adjacent antennas that are stacked.

The antenna system provided in this embodiment of this disclosure can further reduce a transmission loss caused to avoid blocking of an antenna beam by the phase shifter, and can balance a coverage area and transmission quality of an antenna signal. In addition, the antenna system has a small size, low costs, and is easy to assemble. In some embodiments, the plurality of antennas include a first antenna and a second antenna that are stacked in the first direction, the ground is disposed on a side that is of the second antenna and that is away from the first antenna, and the frequency selective surface structure is disposed between the first antenna and the second antenna; and
the first antenna and the second antenna each include a plurality of radiators distributed in an array, and at least a part of the feeding network of the frequency selective surface structure forms the feeding network of the first antenna, and is electrically connected to a plurality of radiators of the first antenna, to feed the plurality of radiators of the first antenna.

In some embodiments, when the frequency selective surface structure includes two metal layers, the feeding network and a phase shifter of the frequency selective surface structure are integrated into a metal layer away from the second antenna in the two metal layers.

In some embodiments, the plurality of radiators of the first antenna form at least one column of radiators, and each of the at least one column of radiators includes at least two radiators spaced apart along a second direction; and when the feeding network of the frequency selective surface structure includes the plurality of transmission line structures, the transmission line structures are symmetrically distributed on the two sides of each column of radiators in the third direction, phase shifters are symmetrically distributed on the two sides of each column of radiators in the third direction, and the first direction, the second direction, and the first direction, the second direction, and the third direction are perpendicular to each other.

According to the foregoing solution, when the first antenna is a dual-polarized antenna, the phase shifter may separately perform phase modulation on two polarization directions of the first antenna.

In some embodiments, the plurality of antennas further include a third antenna, the third antenna is disposed on a side that is of the frequency selective surface structure and that is away from the ground, the third antenna includes a plurality of radiators distributed in an array, and the plurality of radiators of the third antenna and the plurality of radiators of the first antenna are alternately arranged on a plane perpendicular to the first direction; and at least a part of the feeding network of the frequency selective surface structure forms a feeding network of the third antenna, and is electrically connected to the plurality of radiators of the third antenna, to feed the plurality of radiators of the third antenna.

In some embodiments, the plurality of radiators of the third antenna form at least one column of radiators, and each of the at least one column of radiators includes at least two radiators spaced apart along the second direction; and when the feeding network of the frequency selective surface structure includes the plurality of transmission line structures, the transmission line structures are symmetrically distributed on the two sides of each column of radiators in the third direction, the phase shifters are symmetrically distributed on the two sides of each column of radiators in the third direction, and the first direction, the second direction, and the third direction are perpendicular to each other. When the third antenna is a dual-polarized antenna, the phase shifter may separately adjust two polarization directions of the third antenna.

In some embodiments, when the frequency selective surface structure includes the two metal layers, the phase shifter and the feeding network are integrated into each of the two metal layers, a part that is of the feeding network of the frequency selective surface and that forms the feeding network of the first antenna is integrated into either of the two metal layers, and a part that is of the feeding network of the frequency selective surface and that forms the feeding network of the third antenna is integrated into the other one of the two metal layers. A first feeding network and a third feeding network are arranged at different layer. Therefore, wiring is performed on different metal layers, to properly use space.

In some embodiments, the antenna system is formed on a printed circuit board, the printed circuit board includes a metal structure and a dielectric structure, at least a part of the metal structure forms the ground, a plurality of radiators of each of the plurality of antennas, and the metal layer of the frequency selective surface structure, and when the frequency selective surface structure further includes a dielectric layer, at least a part of the dielectric structure of the printed circuit board forms the dielectric layer of the frequency selective surface structure.

An embodiment of this disclosure further provides a base station. The base station includes the antenna system according to any one of the foregoing embodiments and a radio frequency module connected to the antenna system. The base station has high overall integration, a wide signal coverage area, and a small signal coverage hole.

### BRIEF DESCRIPTION OF DRAWINGS

FIG. 1a and FIG. 1b are diagrams of structures of an antenna system in some solutions;

FIG. 2a and FIG. 2b are diagrams of structures of an antenna system in some other solutions;

FIG. 3 is a diagram of an operating principle of a first embodiment of an antenna system according to an embodiment of this disclosure;

FIG. 4a to FIG. 4b-2 are diagrams of structures from a perspective in a first embodiment of an antenna system according to an embodiment of this disclosure;

FIG. 5a to FIG. 5c are diagrams of structures from another perspective in a first embodiment of an antenna system according to an embodiment of this disclosure;

FIG. 6 is a diagram of an operating principle of a second embodiment of an antenna system according to an embodiment of this disclosure;

FIG. 7 is a diagram of a structure of a second embodiment of an antenna system according to an embodiment of this disclosure;

FIG. 8 is a diagram of a structure from another perspective in a second embodiment of an antenna system according to an embodiment of this disclosure;

FIG. 9 is a diagram of a structure of a frequency selective surface structure according to an embodiment of this disclosure;

FIG. 10a is a diagram of a structure of another embodiment of a frequency selective surface structure according to an embodiment of this disclosure;

FIG. 10b is a diagram of a structure of a partial connection of a part A in FIG. 10a;

FIG. 11a is a diagram of a structure of a phase shifter in a frequency selective surface structure according to an embodiment of this disclosure;

FIG. 11b is a diagram of a structure of another embodiment of a phase shifter in a frequency selective surface structure according to an embodiment of this disclosure;

FIG. 12a to FIG. 12c are diagrams of connections between a phase shifter and a metal layer in a frequency selective surface structure according to an embodiment of this disclosure;

FIG. 13a to FIG. 13b-2 are diagrams of structures of a first embodiment of a first transmission line structure in a frequency selective surface structure according to an embodiment of this disclosure, where FIG. 13b-1 is a sectional view in a direction B-B in FIG. 13a, and FIG. 13b-2 is a sectional view in a direction C-C in FIG. 13a;

FIG. 14a is a diagram of a structure of a second embodiment of a first transmission line structure in a frequency selective surface structure according to an embodiment of this disclosure;

FIG. 14b is a diagram of a structure of a third embodiment of a first transmission line structure in a frequency selective surface structure according to an embodiment of this disclosure;

FIG. 15a to FIG. 15b-2 are diagrams of structures of a fourth embodiment of a first transmission line structure in a frequency selective surface structure according to an embodiment of this disclosure, where FIG. 15b-1 is a sectional view in a direction D-D in FIG. 15a, and FIG. 15b-2 is a sectional view in a direction E-E in FIG. 15a;

FIG. 16a and FIG. 16b are diagrams of structures of a fifth embodiment of a first transmission line structure in a frequency selective surface structure according to an embodiment of this disclosure, where FIG. 16b is a sectional view in a direction F-F in FIG. 16a;

FIG. 17 is a diagram of a structure of a sixth embodiment of a first transmission line structure in a frequency selective surface structure according to an embodiment of this disclosure;

FIG. 18 is a diagram of a structure of a seventh embodiment of a first transmission line structure in a frequency selective surface structure according to an embodiment of this disclosure;

FIG. 19 is a diagram of a structure of a power divider in a frequency selective surface structure according to an embodiment of this disclosure;

FIG. 20a to FIG. 20c are diagrams of connections between a transmission line structure and a metal layer in a frequency selective surface structure according to an embodiment of this disclosure; and

FIG. 21 is a diagram of a structure of a base station according to an embodiment of this disclosure.

### REFERENCE NUMERALS

In some solutions:
100′: antenna system; 1′: first antenna; 10′: radiator; 2′: second antenna; 20′: radiator;
3: ground; 4: phase shifter; 5: feeding network; 6: frequency selective surface;
z′: first direction; y′: second direction; x′: third direction.

In some other solutions:
100″: antenna system; 1″: first antenna; 10″: radiator; 2″: second antenna; 20″: radiator;
3″: ground; 4″: phase shifter; 5″: feeding network; 51″: transmission line structure; 6″: frequency selective surface;
z″: first direction; y″: second direction; x″: third direction.

In embodiments of this disclosure:
100: antenna system;
1: first antenna; 10: radiator; 11: first feeding network;
2: second antenna; 20: radiator; 21: second feeding network;
3: third antenna; 30: radiator; 31: third feeding network; 4: ground;
200: frequency selective surface structure;
5: frequency selective surface; 51: metal layer; 511: first metal layer; 512: second metal layer;
513: metal area; 5131: metal grille; 5132: metal patch; 514: hollow area;
6: phase shifter; 61: input terminal; 62: output terminal; 63: external conductor; 63a: bottom;
64: fixed dielectric; 65: sliding dielectric; 66: signal-line winding;
7: feeding network; 71: transmission line structure; 711: first transmission line structure; 7110: cavity;
7111: external conductor; 7111a: bottom; 7112: core; 7113: airgap; 7114: support;
712: power divider; 7121: conductive housing; 7122: electrochemical cell; 7122a: input terminal; 7122b: output terminal;
7123: airgap; 72: feeder;
300: base station; 8: radio frequency module;
z: first direction; y: second direction; x: third direction.

### DESCRIPTION OF EMBODIMENTS

The following describes embodiments of this disclosure by using specific embodiments. A person skilled in the art may easily learn of other advantages and effects of this disclosure based on content disclosed in this specification. Although this disclosure is described with reference to some embodiments, it does not mean that a characteristic of this disclosure is limited only to this implementation. On the contrary, a purpose of describing this disclosure with reference to an implementation is to cover another option or modification that may be derived based on claims of this disclosure. To provide an in-depth understanding of this disclosure, the following descriptions include a plurality of specific details. This disclosure may be alternatively implemented without using these details. In addition, to avoid confusion or blurring a focus of this disclosure, some specific details are omitted from the description. It should be noted that embodiments in this disclosure and the features in embodiments may be mutually combined in the case of no conflict.

In this specification, similar reference numerals and letters in the following accompanying drawings represent similar items. Therefore, once an item is defined in an accompanying drawing, the item does not need to be further defined or interpreted in following accompanying drawings.

The following describes terms that may appear in embodiments of this disclosure.

In descriptions of this disclosure, it is to be noted that orientation or location relationships indicated by terms “center”, “above”, “below”, “left”, “right”, “vertical”, “horizontal”, “inner”, “outer”, and the like are orientation or location relationships based on the accompanying drawings, and are merely intended for conveniently describing this disclosure and simplifying descriptions, rather than indicating or implying that an apparatus or an element in question may have a specific orientation or may be constructed and operated in a specific orientation, and therefore cannot be construed as a limitation on this disclosure. In addition, terms “first” and “second” are merely used for a purpose of description, and shall not be understood as an indication or implication of relative importance.

In descriptions of this disclosure, it is to be noted that unless otherwise expressly specified and limited, terms “mount”, “interconnect”, and “connect” should be understood in a broad sense. For example, the terms may indicate a fixed connection, a detachable connection, or an integral connection; may be a mechanical connection or an electrical connection; or may be direct interconnection, indirect interconnection through an intermediate medium, or communication between the interior of two elements. For a person of ordinary skill in the art, a specific meaning of the foregoing terms in this disclosure may be understood based on a specific situation.

Coupling: The coupling may be understood as direct coupling and/or indirect coupling, and a “coupling connection” may be understood as a direct coupling connection and/or an indirect coupling connection. The direct coupling may also be referred to as an “electrical connection”, and may be understood as physical contact and electrical conduction between components, or may be understood as a form in which different components in a line structure are connected through a physical line that can transmit an electrical signal, for example, a copper foil or a conducting wire of a printed circuit board (PCB). The “indirect coupling” may be understood as electrical conduction between two conductors through air or without contact. In an embodiment, the indirect coupling may also be referred to as capacitive coupling. For example, signal transmission is implemented by forming an equivalent capacitor through coupling in a gap between two conductive members that are spaced apart.

A ground/ground plate may generally represent at least a part of any grounding plane, or grounding plate, or grounding metal layer of a communication device (for example, a base station), or at least a part of any combination of any grounding plane, grounding plate, ground part, or the like. The “ground/ground plate” may be configured to ground a component of the communication device. In an embodiment, the “ground/ground plate” may include any one or more of the following: a grounding plane of a circuit board of the communication device, a grounding plate formed in a middle frame of the communication device, a grounding metal layer formed by a metal film under a screen, a conductive grounding plate of a battery, and a conductive member or a metal member electrically connected to the grounding plane/grounding plate/metal layer. In an embodiment, the circuit board may be a printed circuit board (PCB), for example, an 8-layer, 10-layer, or 12-layer to 14-layer board with 8, 10, 12, 13, or 14 layers of conductive materials, or an element that is separated and electrically insulated by a dielectric layer or an insulation layer, for example, a glass fiber or a polymer. In an embodiment, the circuit board includes a dielectric substrate, a grounding plane, and a wiring layer. The wiring layer and the grounding plane are electrically connected through a via. In an embodiment, parts such as a display, a touchscreen, an input button, a transmitter, a processor, a memory, a battery, a charging circuit, and a system on chip (SoC) structure may be mounted on or connected to the circuit board, or electrically connected to the wiring layer and/or the grounding plane in the circuit board. For example, a radio frequency source is disposed at the wiring layer.

Any grounding plane, grounding plate, or grounding metal layer is made of a conductive material. In an embodiment, the conductive material may be any one of the following materials: copper, aluminum, stainless steel, brass and alloys thereof, copper foil on insulation laminates, aluminum foil on insulation laminates, gold foil on insulation laminates, silver-plated copper, silver-plated copper foil on insulation laminates, silver foil on insulation laminates and tin-plated copper, cloth impregnated with graphite powder, graphite-coated laminates, copper-plated laminates, brass-plated laminates and aluminum-plated laminates. A person skilled in the art may understand that the grounding plane/grounding plate/grounding metal layer may alternatively be made of other conductive materials.

An electrical length may be expressed by multiplying a physical length (namely, a mechanical length or a geometric length) by a ratio of a transmission period of an electrical or electromagnetic signal in a medium to a time period required by this signal to travel, in free space, for a distance that is the same as the physical length of the medium. The electrical length may satisfy the following formula:

$$\overline{L} = L \times \frac{a}{b} .$$

Herein, L is the physical length, and a is the transmission period of the electrical or electromagnetic signal in the medium, and b is the transmission period in the free space.

Alternatively, the electrical length may be a ratio of a physical length (namely, a mechanical length or a geometric length) to a wavelength of a transmitted electromagnetic wave. The electrical length may meet the following formula:

$$\overline{L} = \frac{L}{λ} .$$

L is the physical length, and λ is the wavelength of the electromagnetic wave.

A dielectric constant is a main parameter that reflects a dielectric or polarization property of a dielectric under an action of an electrostatic field.

Transmission is a front-to-back ratio of an electromagnetic wave that passes through a medium such as glass. Higher transmission indicates that more electromagnetic waves pass through the medium, and lower transmission indicates that fewer electromagnetic waves pass through the medium.

Reflectivity is a ratio of reverse signals received by an antenna to forward signals, namely, a ratio of reflected waves to incident waves.

An antenna pattern is also referred to as a radiation pattern, and is a pattern of a change of relative field strength (normalized modulus value) of an antenna radiation field with a direction at a distance from an antenna.

Limitations such as collinearity, coaxiality, coplanarity, symmetry (for example, axisymmetricity or centrosymmetry), parallelism, perpendicularity, and sameness (for example, a same length and a same width) mentioned in embodiments of this disclosure are for a current technology level, but are not strict definitions in a mathematical sense. A deviation of a predetermined angle (for example, ±5° or)±10° may exist between two structures that are parallel or perpendicular to each other.

To make the objectives, technical solutions, and advantages of this disclosure clearer, the following further describes the embodiments of this disclosure in detail with reference to the accompanying drawings.

A base station antenna is the basis of current mobile communication and plays an important role in mobile communication. A higher-rate and larger-capacity communication system than the existing systems may meet the increasing mobile communication rates and bandwidth requirements. A base station antenna system is evolving from a 4th generation (4G) mobile communication technology to a 5th generation (5G) mobile communication technology. A current key technology is to provide a multi-band integrated antenna system for an operator.

In an existing multi-band integrated antenna system, antennas on a plurality of bands are stacked, and a corresponding feeding network is disposed for each layer of antenna. Because a plurality of antennas in the antenna system are stacked, signals between the antennas on the bands interfere with each other, and consequently, an antenna radiation pattern is distorted. Structures such as a phase shifter and a frequency selective surface are usually disposed in the multi-band integrated antenna system, to reduce mutual impact between antennas on different bands and obtain a required antenna waveform. Flexible beam scanning is implemented by changing a band-pass characteristic, a band-stop characteristic, phase modulation, and the like of the feeding network, to reduce a coupling effect between the antennas on the different bands, thereby obtaining an ideal antenna waveform, increasing a coverage area of a base station antenna, and adapting to mounting and layout requirements in a plurality of scenarios.

However, when multi-band antenna array layout density is high, layout of the phase shifter becomes a difficult problem. Because the phase shifter is to be connected to the feeding network of the antenna, when the plurality of antennas are stacked, a part of phase shifters may be arranged between the stacked antennas along with the feeding network of the antenna. The phase shifter has a size, and therefore, blocks beams of a part of antennas, affecting a coverage area of an antenna signal. Consequently, a user directly feels a too slow network speed or a signal coverage hole is generated in a part of areas.

To prevent the phase shifter from blocking the antenna waveform, some operators improve layout of the antenna system and the phase shifter, by using methods like separate layout or the like to stagger the phase shifter and an affected antenna. This method can mitigate, to some extent, a phenomenon that the phase shifter blocks an antenna beam, but lead to drawbacks such as increased antenna size, less compact layout. Consequently, a transmission line structure between the phase shifter and the feeding network is extended, resulting in a higher loss due to long-distance transmission. Therefore, in the conventional technology, it is difficult to arrange a phase shifter of a multi-band integrated antenna system. A high transmission loss is caused to avoid blocking of an antenna beam by the phase shifter, and a coverage area and transmission quality of an antenna signal cannot be balanced.

The following uses two antenna systems as an example to describe a problem of arranging a phase shifter in an antenna system.

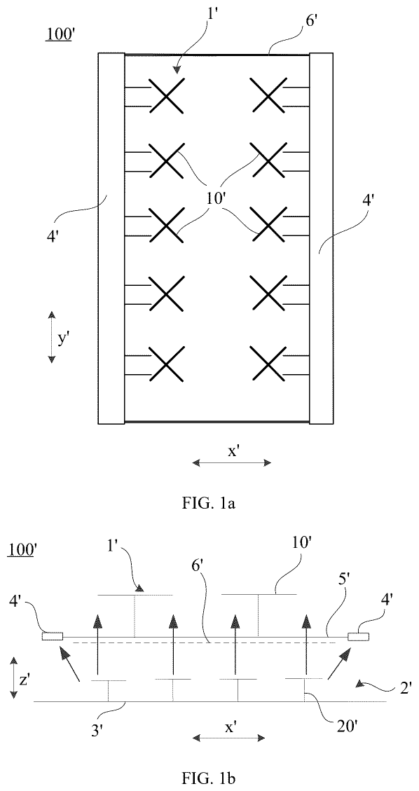

FIG. 1a and FIG. 1b are diagrams of structures of an antenna system in some solutions.

As shown in FIG. 1a and FIG. 1b, an antenna system 100′ includes a first antenna 1′ and a second antenna 2′ that are stacked in a first direction z′, a ground 3′ is placed below the second antenna 2′, the first antenna 1′ is located above the second antenna 2′, and a frequency selective surface 6′ of a feeding network 5′ integrated with the first antenna 1′ and a phase shifter 4′ connected to the feeding network 5′ are disposed between the first antenna 1′ and the second antenna 2′. The first antenna 1′ and the second antenna 2′ each include a plurality of radiators, a plurality of radiators of each antenna form a plurality of columns of radiators, each column of radiators includes at least two radiators that are spaced apart along a second direction y′, and the plurality of columns of radiators are arranged in a third direction x′. An electromagnetic wave of the second antenna 2′ is entirely radiated, along a first direction z′, toward a side on which the first antenna 1′ is located. To reduce blocking of a beam of the second antenna 2′ by the phase shifter 4′, in the third direction x′, the phase shifter 4′ is arranged on two sides of all radiators 10′ of the first antenna 1′, and the phase shifter 4′ is located outside two sides of the frequency selective surface 6′. In this structure, when electromagnetic waves of radiators 20′ of the second antenna 2′ are radiated vertically (radiated, along the first direction z′, toward the side on which the first antenna 1′ is located), the phase shifter 4′ does not block the beam of the second antenna 2′. However, when the radiator 20′ of the second antenna 2′ is radiated along a direction that has an included angle with the first direction z′, the phase shifter 4′ still blocks the beam of the second antenna 2′, thereby increasing a wave transmission loss of the second antenna 2′, affecting a coverage area of an antenna signal, and causing problems such as a slow network speed and a signal coverage hole in some areas. In addition, this layout manner increases a size of the antenna system in the third direction, and affects competitiveness of a base station antenna product.

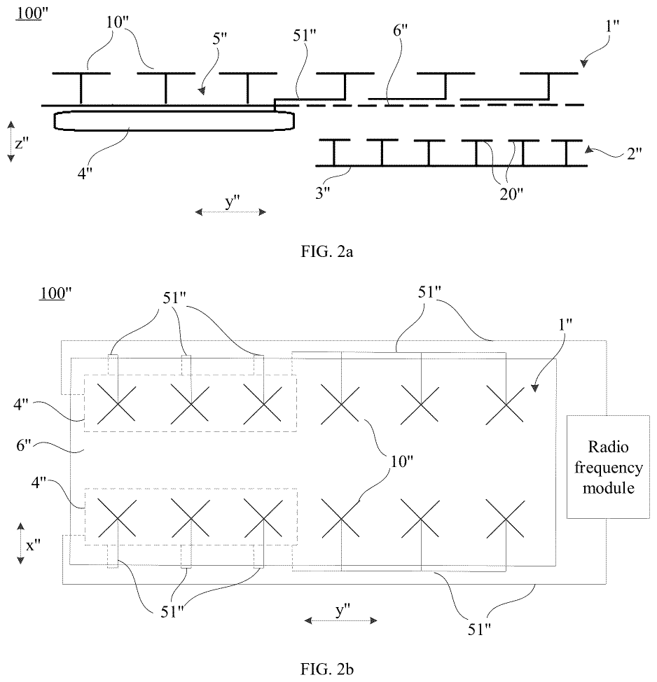

FIG. 2a and FIG. 2b are diagrams of structures of an antenna system in some other solutions.

As shown in FIG. 2a and FIG. 2b, an antenna system 100″ includes a first antenna 1″ and a second antenna 2″ that are stacked in a first direction z″, a ground 3″ is connected below the second antenna 2″, the first antenna 1″ is located above the second antenna 2″, and a feeding network 5″ of the first antenna 1″ is disposed between the first antenna 1″ and the second antenna 2″. The first antenna 1″ and the second antenna 2″ each include a plurality of radiators, a plurality of radiators of each antenna form a plurality of columns of radiators, each column of radiators includes at least two radiators that are spaced apart along a second direction y″, and the plurality of columns of radiators are arranged in a third direction x″. A plurality of radiators 20″ of the second antenna 2″ are centrally arranged in an area, and only a part of the first antenna 1″ and the second antenna 2″ are stacked. To reduce blocking of a beam of the second antenna by a phase shifter 4″, the phase shifter 4″ is arranged at a position at which the second antenna 2″ is not disposed, to stagger the phase shifter 4″ and the second antenna 2″ in the second direction y″. The phase shifter 4″ and the second antenna 2″ are not stacked in the first direction z″. In addition, a frequency selective surface 6″ is disposed right above the second antenna 2″, the frequency selective surface 6″ is an electromagnetically transparent structure for the second antenna 2″, and an electromagnetic wave radiated by the second antenna 2″ can pass through the frequency selective surface 6″. In this structure, the beam of the second antenna 2″ is not blocked by the phase shifter 4″. However, because a phase of each radiator 10″ of the first antenna 1″ may be adjusted and controlled by using the phase shifter 4″, the phase shifter 4″ is electrically connected to each radiator 10″ of the first antenna 1″ through a transmission line structure 51″ (for example, a cable or a microstrip). The phase shifter 4″ is disposed on a side that is of the frequency selective surface 6″ and that is away from the radiator 10″ of the first antenna 1″. Consequently, a length of a transmission line structure 51″ between the phase shifter 4″ and each radiator 10″ of the first antenna 1″ is long, and a transmission loss is large. Especially, for a radiator 10″ located right above the second antenna 2″, a distance between radiator 10″ and the phase shifter 4″ in the second direction y″ is long. Consequently, a length of the transmission line structure 51″ between the phase shifter 4″ and the radiator 10″ increases, and the transmission loss increases. In addition, the transmission line structure 51″ is fastened to the frequency selective surface 6″. When the length of the transmission line structure 51″ is long, a quantity of manual welding points is also increased, and an assembly is complex. When the transmission line structure 51″ uses a low-loss microstrip, more radio frequency plates are required, and costs are increased.

To resolve the foregoing problem, this disclosure provides an antenna system. Both a phase shifter and a feeding network are integrated into a frequency selective surface, the phase shifter is hidden. In this way, a length of a transmission line structure in the feeding network can be further shortened, and a transmission loss caused to avoid blocking of an antenna beam by the phase shifter can be reduced.

The technical solutions in embodiments of this disclosure may be applied to various communication systems such as a multi-band integrated antenna system, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a 5th generation (5G) system or a new radio (NR) system, a device to device (D2D) system, and a vehicle to everything (V2X) system.

The following describes examples of the technical solutions used for the antenna system in this disclosure and beneficial effects thereof with reference to several structures of the multi-band antenna system.

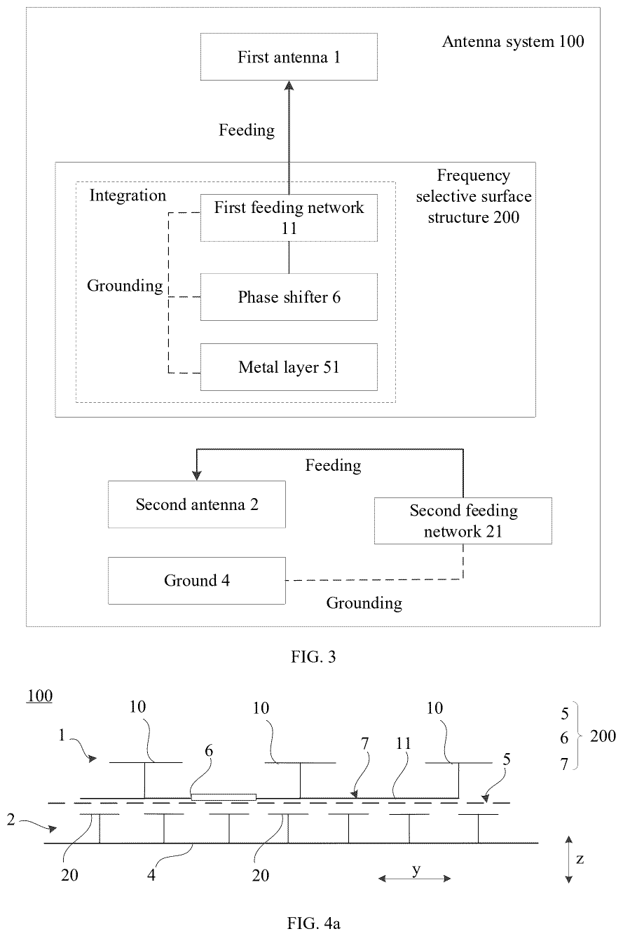

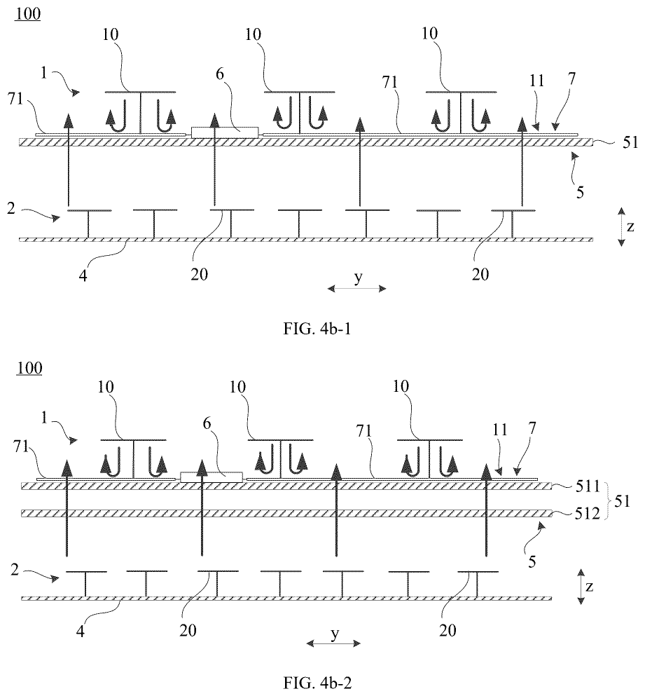

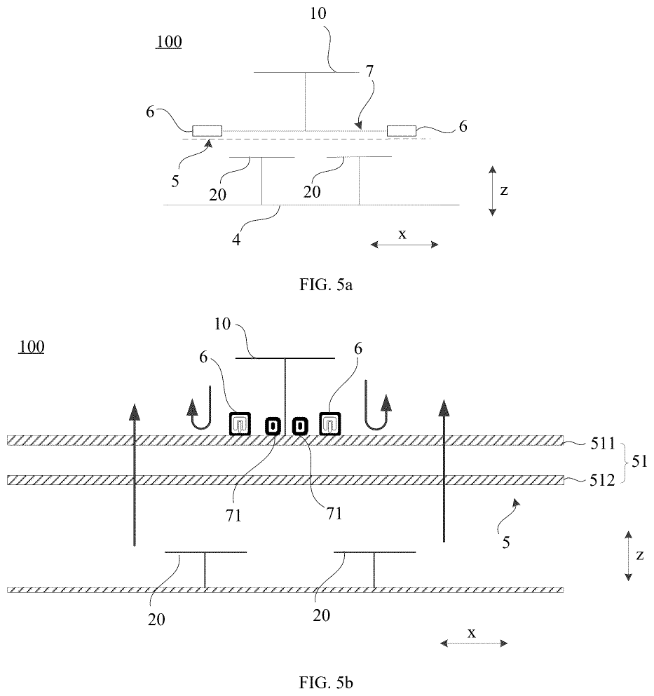

FIG. 3 is a diagram of an operating principle of a first embodiment of an antenna system according to an embodiment of this disclosure. FIG. 4a to FIG. 4b-2 are diagrams of structures from a perspective in a first embodiment of an antenna system according to an embodiment of this disclosure. FIG. 5a to FIG. 5c are diagrams of structures from another perspective in a first embodiment of an antenna system according to an embodiment of this disclosure.

As shown in FIG. 3 to FIG. 5c, an antenna system 100 includes a ground 4, a plurality of antennas stacked in a first direction z, and a plurality of feeding networks 7 configured to feed the plurality of antennas. The ground 4 is disposed on one side of the plurality of antennas in the first direction z. The antenna is configured to receive or send a signal. A person skilled in the art may understand that a type of each antenna is not limited, and may be an active antenna, a passive antenna, a single-polarized antenna, a dual-polarized antenna, a directional antenna, an omnidirectional antenna, or the like. The active antenna is an antenna that integrates modules such as a receive antenna module, a low noise amplification module, and a power supply module, and requires an additional power supply. The active antenna may have a plurality of input and output ports, and a circuit of the active antenna is complex. The passive antenna is an antenna without any active device, and usually has a single output port. The passive antenna has a simple structure and low costs, and is easy to mount. The dual-polarized antenna combines antennas with two mutually orthogonal polarization directions of +45° and −45°, and may simultaneously operate in a receive and transmit duplex mode. This reduces a quantity of antennas of a single directional base station. Using the dual-polarized antenna in a mobile communication network may reduce interference and improve service quality of the entire network. Therefore, the dual-polarized antenna is usually used in the mobile communication network. Single polarization is polarization in a horizontal direction or a vertical direction. Compared with the dual-polarized antenna, the single-polarized antenna has better coverage effect in areas such as an open plain or a mountainous area. The antenna system 100 may include a plurality of types of antennas such as the active antenna, the passive antenna, the single-polarized antenna, and the dual-polarized antenna, and may be designed based on an actual disclosure scenario.

Each antenna includes a plurality of radiators (also referred to as radiating elements), to radiate an electromagnetic wave or receive an electromagnetic wave through the radiator. A specific form of the radiator is not limited. For example, the radiator may include an antenna element. The antenna element may be briefly referred to as an element, and has a function of directing and amplifying an electromagnetic wave.

The ground 4 is also referred to as a reflection panel, a bottom plate, or an antenna panel, and is configured to reflect the electromagnetic wave, so that electromagnetic waves of antennas are centrally radiated in one direction, and may be further configured to ground the antennas. The feeding network is also referred to as a power distribution network, and is configured to feed power to the antenna. Feeding may be supplying power to the antenna or providing energy. A function of the feeding network is to feed a signal to each radiator of the antenna based on a specific amplitude and a specific phase, or feed a signal received from each radiator to a signal processing unit of a base station based on a specific amplitude and a specific phase. A corresponding feeding network is disposed for each of the plurality of antennas. Feeding networks of different antennas may be independent, or may be shared. For example, two antennas share one feeding network. This is not limited in this disclosure.

A person skilled in the art understands that a specific quantity of antennas in the antenna system 100 is not limited. For example, there may be two, three, four, or more antennas. As an example, the plurality of antennas include a first antenna 1 and a second antenna 2 that are stacked, the first antenna 1 includes a plurality of radiators 10 distributed in an array, the second antenna 2 includes a plurality of radiators 20 distributed in an array, and the ground 4 is disposed on a side that is of the second antenna 2 and that is away from the first antenna 1.

A specific quantity and a layout manner of the radiators 10 of the first antenna 1 are not limited, and may be designed based on an actual disclosure scenario. As an example, the plurality of radiators 10 of the first antenna 1 form at least one column of radiators 10, and each column of radiators 10 includes at least two radiators 10 that are spaced apart along a second direction y. The first direction z, the second direction y, and a third direction x are perpendicular to each other. Alternatively, it may be understood that the plurality of radiators 10 of the first antenna 1 are distributed in a rectangular array, the second direction y may be a length direction of the rectangular array, the third direction x may be a width direction of the rectangular array, the plurality of radiators 10 arranged in the rectangular array along the length direction form one column of radiators 10, at least one column (for example, one column, two columns, or three columns, which is not limited, and one column is shown in the figure for illustration) of radiators 10 is arranged along the width direction of the rectangular array, and a quantity of radiators 10 in one column of radiators 10 is at least two (for example, two, three, or four, which is not limited, and several radiators are shown in the figure for illustration). Similarly, a specific quantity and a layout manner of the radiators 20 of the second antenna 2 are not limited. For example, the radiators 20 may be arranged in a rectangular array or in an array of another shape. Details are not described herein again.

Further, the antenna system 100 further includes a first feeding network 11 that feeds power to the first antenna 1 and a second feeding network 21 that feeds power to the second antenna 2. The first feeding network 11 is located between the first antenna 1 and the second antenna 2 in the first direction z, and is electrically connected to each radiator 10 of the first antenna 1. The second feeding network 21 is electrically connected to each radiator 20 of the second antenna 2, and may be at any position on a side that is of the first feeding network 11 and that is away from the first antenna 1, for example, may be integrated into the ground 4. This is not limited in this disclosure. As an example, the second feeding network 21 is further electrically connected to the ground 4, to implement grounding.

In perspectives in FIG. 4a to FIG. 5c, the antenna system 100 is horizontally placed, and both the first antenna 1 and the second antenna 2 are located above the ground 4. However, in an actual disclosure scenario, a placement manner of the antenna system 100 is not limited. The antenna system 100 may be placed horizontally (the ground 4 is parallel to a horizontal ground), or may be placed vertically (the ground 4 is perpendicular to a horizontal ground). In an example scenario, the antenna system 100 is vertically placed, and the ground 4 is perpendicular to the horizontal ground, so that more radiators of the first antenna 1 and the second antenna 2 are arranged in a vertical direction (namely, the second direction y), and a signal of the antenna system 100 has a wider coverage area in the vertical direction, for example, may cover each floor of a high building.

Further, the antenna system 100 further includes a frequency selective surface 5 (FSS) disposed between stacked antennas. The frequency selective surface 5 is a two-dimensional periodic array structure, may effectively control transmission and reflection of the electromagnetic wave, and has a specific frequency selection function. The frequency selective surface 5 may be a spatial filter, and interacts with the electromagnetic wave to exhibit an obvious band-pass or band-stop filtering characteristic. A person skilled in the art may understand that a specific form of the frequency selective surface 5 is not limited. For example, the frequency selective surface 5 may transmit, reflect, or transmit and reflect an incident electromagnetic wave. Refer to arrow directions in FIG. 4b-1, FIG. 4b-2, FIG. 5b, and FIG. 5c. As an example, the frequency selective surface 5 transmits an electromagnetic wave of the second antenna 2, and reflects an electromagnetic wave of the first antenna 1. The electromagnetic wave radiated by the second antenna 2 is reflected on the ground 4, and may be radiated upward through the frequency selective surface 5. That is, the frequency selective surface 5 is of an electromagnetically transparent structure for the second antenna 2. All electromagnetic waves of the second antenna 2 are radiated, in the second direction y, toward a direction away from the ground 4. The electromagnetic wave of the first antenna 1 is reflected on the frequency selective surface 5 (or may be understood as that the frequency selective surface 5 serves as a ground of the first antenna 1), so that the electromagnetic wave of the first antenna 1 can be radiated, in the first direction z, toward a direction away from the ground 4. Radiation directions of the first antenna 1 and the second antenna 2 are consistent.

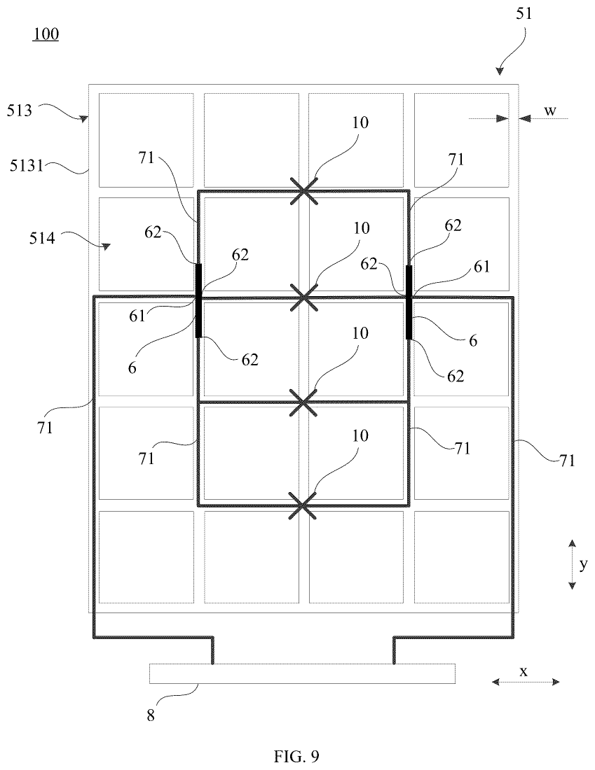

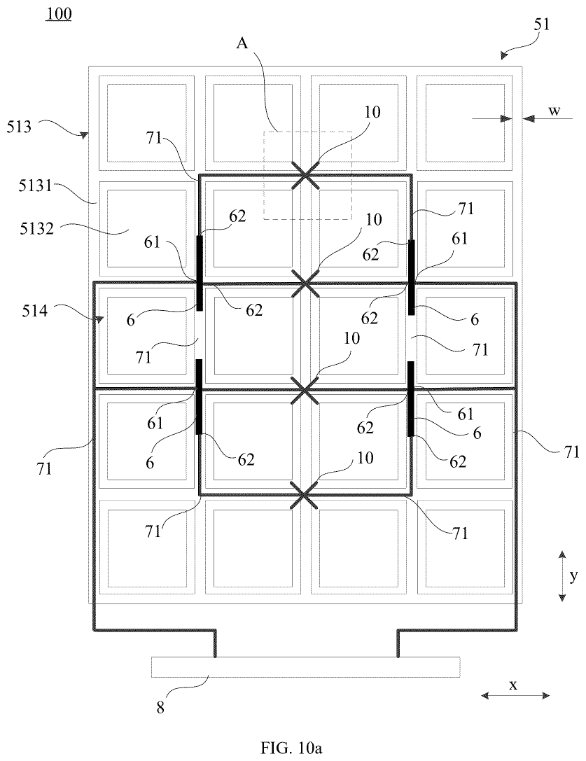

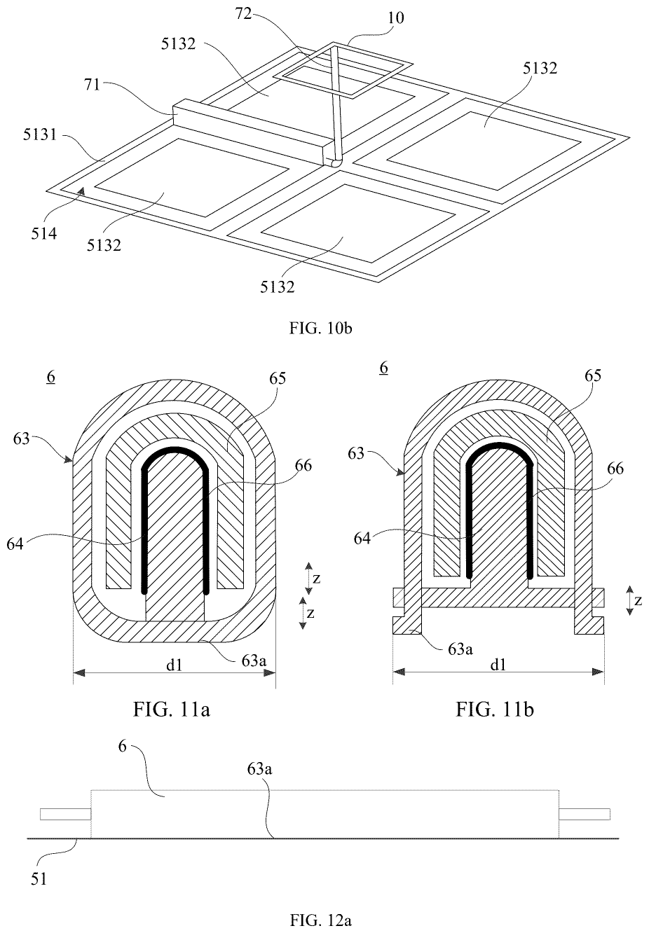

The frequency selective surface 5 includes a metal layer 51. The metal layer 51 is a structure that actually has a spatial filtering function on the frequency selective surface 5. The metal layer 51 may include a metal area 513 formed by using metals of various shapes (as shown in FIG. 9 to FIG. 10b). A design of the metal area 513 enables the frequency selective surface 5 to present a band-pass or band-stop characteristic. Details are described in detail below.

Further, a phase shifter 6 and the feeding network 7 are integrated into the metal layer 51 of the frequency selective surface 5. In this way, the frequency selective surface 5, the phase shifter 6, and the feeding network 7 form a frequency selective surface structure 200. The phase shifter 6 is an apparatus that can modulate a phase of an output signal of an antenna. As an example, the phase shifter 6 is electrically connected to each radiator 10 of the first antenna 1 through the feeding network 7 of the frequency selective surface structure 200, to control a radiation direction of each radiator 10 and obtain a required antenna waveform. The feeding network 7 of the frequency selective surface structure 200 may include a transmission line structure 71 used for signal transmission, for example, a coaxial cable or a microstrip. The feeding network 7 forms a feeding network 7 of at least one antenna away from the ground 4 in adjacent antennas that are stacked. As an example, the feeding network 7 forms the first feeding network 11. To be specific, the first feeding network 11 is integrated into the metal layer 51 of the frequency selective surface 5.

The phase shifter 6 and the first feeding network 11 are integrated into the metal layer 51 of the frequency selective surface 5. A miniaturized phase shifter 6 may be used, and the phase shifter 6 and the transmission line structure 71 in the feeding network 7 are hidden in the metal area 513 of the metal layer 51. The metal layer 51 hides the phase shifter 6 and the feeding network 7. “Hiding” may be understood as that a projection of the phase shifter 6 and the feeding network 7 onto the metal layer 51 along the first direction z is entirely located in the metal area 513. In this form, the phase shifter 6 and the feeding network 7 do not affect a spatial filtering characteristic of the frequency selective surface 5, so that the frequency selective surface 5 still performs reflection for the first antenna 1 and performs transmission for the second antenna 2. In addition, the phase shifter 6 and the feeding network 7 do not block the electromagnetic wave of the second antenna 2. In addition, compared with the antenna system in FIG. 1a and FIG. 1b, the phase shifter 6 in the antenna system 100 in this disclosure does not need be disposed on two sides of each radiator of the first antenna 1, and therefore, the antenna system 100 has a small size. Compared with the antenna system in FIG. 2a and FIG. 2b, because the phase shifter 6 and the feeding network 7 of the antenna system 100 in this disclosure are integrated together, a structure is compact, a length of the transmission line structure 71 in the feeding network 7 may be shortened, and a transmission loss is reduced. The length of the transmission line structure 71 is shortened, and too many manual welding points and radio frequency plates are avoided. Costs are low, and an assembly is simpler.

Therefore, when the phase shifter 6 does not block an antenna beam, the antenna system 100 provided in this embodiment of this disclosure can further reduce a transmission loss, and can balance a coverage area and transmission quality of an antenna signal. In addition, the antenna system 100 has a small size, low costs, and is easy to assemble.

A person skilled in the art may understand that a quantity of metal layers 51 of the frequency selective surface 5 is not limited. There may be one, two, three, or more metal layers 51. When there are a plurality of metal layers 51 of the frequency selective surface 5, the phase shifter 6 and the feeding network 7 are integrated into at least one of the metal layers 51. As shown in FIG. 4b-1, as an example, the frequency selective surface 5 includes one metal layer 51. As shown in FIG. 4b-2, FIG. 5b, and FIG. 5c, as another example, the frequency selective surface 5 includes two metal layers 51 that are stacked in the first direction z: a first metal layer 511 and a second metal layer 512. The second metal layer 512 is located between the first metal layer 511 and the second antenna 2 in the first direction z. Further, the first metal layer 511 and the second metal layer 512 each include two surfaces that face away from each other in the first direction z, and the feeding network 7 and the phase shifter 6 may be integrated on any one or more surfaces of the two metal layers. As shown in FIG. 4b-2 and FIG. 5b, as an example, both the phase shifter 6 and the feeding network 7 are integrated into the first metal layer 511, and are located on a surface of a side that is of the first metal layer 511 and that faces away from the second metal layer 512. As shown in FIG. 5c, as an example, the phase shifter 6 and the feeding network 7 may alternatively be integrated on a surface of a side that is of the first metal layer 511 and that is close to a side of the second metal layer 512. In another alternative embodiment, the phase shifter 6 and the feeding network 7 may alternatively be integrated into the first metal layer 511 and the second metal layer 512. Examples are not listed one by one herein.

A person skilled in the art may understand that a specific quantity and a layout manner of the phase shifter 6 are not limited, and a specific quantity and a layout manner of the transmission line structure 71 in the feeding network 7 are not limited. As an example, the first antenna 1 is a dual-polarized antenna, the frequency selective surface structure 200 includes a plurality of phase shifters 6, and the feeding network 7 includes a plurality of transmission line structures 71. In addition, transmission line structures 71 are symmetrically distributed on two sides of each column of radiators 10 of the first antenna 1 in the third direction x, and phase shifters 6 are symmetrically distributed on two sides of each column of radiators 10 in the third direction x. In this form, the phase shifter 6 may separately perform phase modulation on two polarization directions of the first antenna 1. In another alternative embodiment, if the first antenna 1 is a single-polarized antenna, the phase shifter 6 and the transmission line structure 71 in the feeding network 7 may alternatively be distributed on one side of the first antenna 1.

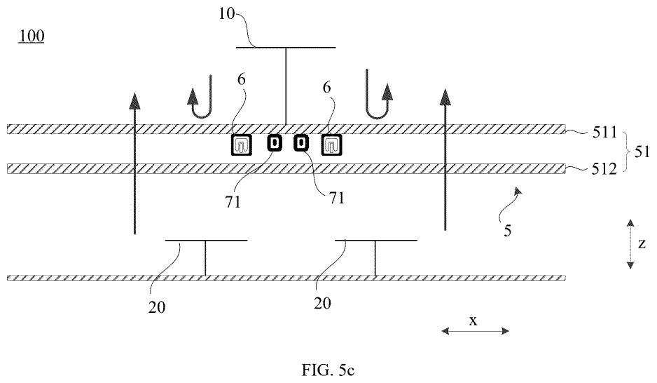

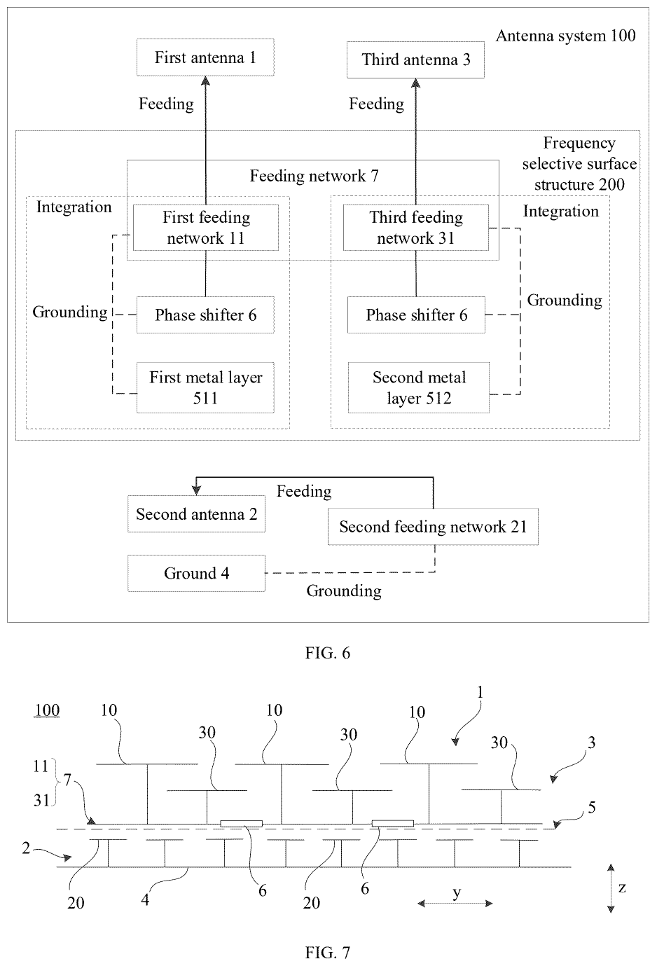

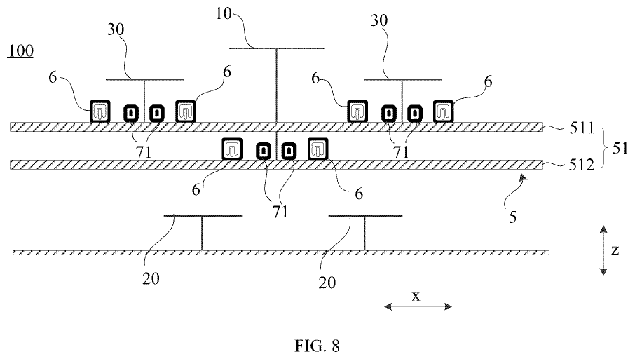

FIG. 6 is a diagram of an operating principle of a second embodiment of an antenna system according to an embodiment of this disclosure. FIG. 7 is a diagram of a structure in a second embodiment of an antenna system according to an embodiment of this disclosure. FIG. 8 is a diagram of a structure from another perspective in a second embodiment of an antenna system according to an embodiment of this disclosure.

As shown in FIG. 6 to FIG. 8, as an example, a third antenna 3 is further disposed in the antenna system 100, and the third antenna 3 is disposed on a side that is of the frequency selective surface structure 200 and that faces away from the ground 4. Similarly, a type of the third antenna 3 is not limited. As an example, the third antenna 3 is a dual-polarized antenna.

Further, the third antenna 3 includes a plurality of radiators 30 distributed in an array, and the plurality of radiators 30 of the third antenna 3 and the plurality of radiators 10 of a first antenna 1 are alternately arranged on a plane perpendicular to the first direction z. A third feeding network 31 is correspondingly disposed for the third antenna 3, and at least a part of the feeding network 7 of the frequency selective surface structure 200 forms the third feeding network 31, and is electrically connected to the plurality of radiators 30 of the third antenna 3, to feed the plurality of radiators 30 of the third antenna 3. Alternatively, it may be understood that the first antenna 1 and the third antenna 3 are located in a same layer structure in the first direction z, the radiator 10 of the first antenna 1 and the radiator 30 of the third antenna 3 are distributed in a cross manner in the layer structure, the third feeding network 31 of the third antenna 3 is also integrated into the metal layer 51 of the frequency selective surface 5, and the feeding network 7 of the frequency selective surface structure 200 forms both the first feeding network 11 and the third feeding network 31. The first antenna 1 and the third antenna 3 may separately operate on different bands. For example, the first antenna 1 may be a 4G antenna, and the third antenna 3 may be a 3G antenna. This is not limited in this disclosure.

A specific quantity and a layout manner of the radiators 30 of the third antenna 3 are not limited, and may be designed based on an actual disclosure scenario. As an example, the plurality of radiators 30 of the third antenna 3 form at least one column of radiators, and each radiator includes at least two radiators 30 spaced apart along the second direction y. Alternatively, it may be understood that the plurality of radiators 30 of the third antenna 3 are distributed in a rectangular array, the second direction y may be a length direction of the rectangular array, the third direction x may be a width direction of the rectangular array, the radiators 30 arranged in the rectangular array along the length direction form one column of radiators, at least one column (for example, one column, two columns, or three columns, which is not limited) of radiators is arranged along the width direction of the rectangular array, and a quantity of radiators 30 in one column of radiators is at least two (for example, two, three, or four, which is not limited, and several radiators are shown in the figure for illustration).

As shown in FIG. 8, as an example, the first antenna 1 has one column of radiators 10, the third antenna 3 has two columns of radiators 30, and the two columns of radiators 30 of the third antenna 3 are distributed on two sides of the one column of radiator 10 of the first antenna 1 along the second direction y.

As an example, transmission line structures 71 are symmetrically distributed on two sides of each column of radiators of the third antenna 3 in the third direction x, and phase shifters 6 are symmetrically distributed on two sides of each column of radiators in the third direction x. In this form, the phase shifter 6 and the feeding network 7 may separately adjust two polarization directions of the third antenna 3. In another alternative embodiment, if the third antenna 3 is a single-polarized antenna, the phase shifter 6 and the transmission line structure 71 in the feeding network 7 may alternatively be distributed on one side of the third antenna 3.

As shown in FIG. 8, as an example, the phase shifter 6 and the feeding network 7 are integrated into each of the first metal layer 511 and the second metal layer 512, the first feeding network 11 is integrated into the second metal layer 512, the third feeding network 31 is integrated into the first metal layer 511, the phase shifter 6 at the first metal layer 511 is electrically connected to a transmission line structure 71 in the third feeding network 31, and the phase shifter 6 at the second metal layer 512 is electrically connected to a transmission line structure 71 in the first feeding network 11. The first feeding network 11 and the third feeding network 31 are arranged at different layer. Therefore, wiring is performed on different metal layers 51, to properly use space. In another alternative embodiment, the first feeding network 11 may also be integrated into the first metal layer 511, and the second feeding network 21 may also be integrated into the second metal layer 512. This is not limited in this disclosure.

The foregoing systematically describes a structure of the antenna system 100 provided in this embodiment of this disclosure, a function of each part, and a basic principle that the phase shifter 6 in the antenna system 100 does not block the antenna beam. The following describes, with reference to the frequency selective surface structure 200, a manner of integrating the phase shifter 6 and the feeding network 7 on the frequency selective surface 5.

FIG. 9 is a diagram of a structure of a frequency selective surface structure according to an embodiment of this disclosure. FIG. 10a is a diagram of a structure of another embodiment of a frequency selective surface structure according to an embodiment of this disclosure. FIG. 10b is a diagram of a structure of a partial connection of a part A in FIG. 10a.

As shown in FIG. 9 to FIG. 10b, a frequency selective surface structure 200 includes a frequency selective surface 5, a feeding network 7, and a phase shifter 6. The frequency selective surface 5 includes a metal layer 51, a phase shifter 6 is electrically connected to the feeding network 7, and the phase shifter 6 and the feeding network 7 are integrated into the metal layer 51 of the frequency selective surface 5.

The frequency selective surface structure 200 provided in this embodiment of this disclosure can be applied to an antenna system 100, and both the phase shifter 6 and the feeding network 7 are integrated into the metal layer 51 of the frequency selective surface 5. The metal layer 51 of the frequency selective surface 5 has a spatial filter characteristic, and a wave transmission characteristic of an antenna is changed by designing the metal layer 51, to meet a requirement for transmitting and adjusting and controlling of an electromagnetic wave of the antenna. The frequency selective surface 5 may be designed to completely transmit a part of antennas (for example, a second antenna 2 in the antenna system 100), that is, to be of a structure electromagnetically transparent to the part of antennas. The phase shifter 6 and the feeding network 7 are integrated into the metal layer 51. The metal layer 51 hides the phase shifter 6. If a miniaturized phase shifter 6 is used, the phase shifter 6 may be completely hidden on one side of the metal layer 51. In addition, the metal layer 51 also hides a transmission line structure 71 in the feeding network 7. The feeding network 7 and the phase shifter 6 do not affect a filtering characteristic of the frequency selective surface structure 200. In this way, the frequency selective surface structure 200 jointly including the frequency selective surface 5, the phase shifter 6, and the feeding network 7 can still be electromagnetically transparent to the part of antennas. Therefore, beams of the part of antennas are not blocked. The other part of antennas (for example, a first antenna 1 and a third antenna 3 in the antenna system 100) may be disposed on the other side of the frequency selective surface structure 200. In this way, electromagnetic waves of the other part of antennas are radiated in a direction away from the frequency selective surface structure 200, and the phase shifter 6 does not block beams of the other part of antennas. Further, because the phase shifter 6 and the feeding network 7 are integrated together, a structure is compact, a length of the transmission line structure 71 in the feeding network 7 may be shortened, and a transmission loss is reduced.

Therefore, the frequency selective surface structure 200 provided in this embodiment of this disclosure can further reduce the transmission loss when the phase shifter 6 does not block an antenna beam, and can balance a coverage area and transmission quality of an antenna signal, thereby resolving a problem that it is difficult to arrange a phase shifter 6 in a multi-band integrated antenna system 100.

A person skilled in the art may understand that a specific shape of the metal layer 51 is not limited. As an example, the metal layer 51 has a metal area 513, and a hollow area 514 is enclosed in the metal area 513. The feeding network 7 and the phase shifter 6 are integrated into the metal area 513, and a projection of the feeding network 7 and the phase shifter 6 onto the metal layer 51 along a first direction z is entirely located in the metal area 513. The metal layer 51 is entirely located on a plane perpendicular to the first direction z, and the first direction z is perpendicular to a plane on which the metal layer 51 is located. Alternatively, it may be understood that the entire metal layer 51 is a layered structure made of a metal material. A part of an area of the layered structure is hollowed, and is processed to form a metal pattern. The hollowed part forms the hollow area 514, and a remaining solid structure part is the metal area 513.

The phase shifter 6 and the feeding network 7 are integrated into the metal area 513, and are carried in the metal area 513. That the projection of the feeding network 7 and the phase shifter 6 onto the metal layer 51 along the first direction z is entirely located in the metal area 513 may be understood as that the phase shifter 6 and the feeding network 7 are not stacked with the hollow area 514 in the first direction z, to prevent the phase shifter 6 and the feeding network 7 from blocking the antenna beam (for example, blocking a beam of the second antenna 2 in the antenna system 100). The projection of the feeding network 7 and the phase shifter 6 onto the metal layer 51 in the first direction z is not necessarily located in the metal area 513, and a deviation is allowed. For example, a small part may exceed the metal area 513. Although the part that exceeds the metal area 513 also blocks the antenna beam to some extent, when the part that exceeds the metal area 513 is small enough, the antenna beam is not obviously blocked, and impact on an antenna pattern may be ignored. In this case, a transmission loss can also be reduced when the phase shifter 6 does not block the antenna beam.

A person skilled in the art may understand that the specific shape of the metal layer 51 is not limited. For example, the metal area 513 of the metal layer 51 may be of a grille shape, a patch shape, a slot shape, or the like. As shown in FIG. 9, as an example, the metal layer 51 includes a metal grille 5131, the metal grille 5131 forms the metal area 513, and space enclosed by the grids of the metal grille 5131 jointly forms the hollow area 514. The frequency selective surface 5 of a grille shape has a regular shape and easy to process, and it is easy to perform wiring on a grid line in the grille. As shown in FIG. 10a and FIG. 10b, as an example, the frequency selective surface 5 may be formed in a manner of a metal grille and a metal patch. A metal patch 5132 is disposed in each grid of the metal grille 5131. The metal grille 5131 and the metal patch 5132 jointly form the metal area 513, and a gap between the metal patch 5132 and the metal grille 5131 jointly form the hollow area 514. A shape of the metal patch 5132 is not limited, and may be, for example, a circle, a square, or a triangle. As an example, a shape of the metal patch 5132 is in a square.

As an example, the frequency selective surface structure 200 further includes a dielectric layer (not shown in the figure), and the metal layer 51 is mounted at the dielectric layer. The dielectric layer may be configured to support the metal layer 51. For example, the metal layer 51 may be attached to a surface of the dielectric layer, or the metal layer 51 is embedded in the dielectric layer. The hollow area 514 of the metal layer 51 may also be filled with a medium. The dielectric layer is made of a non-metal material, for example, glass or ceramic. This is not limited. A person skilled in the art may understand that a shape and a location of the dielectric layer are not limited, provided that the dielectric layer can provide a support force for the metal layer 51. In an example scenario, when the frequency selective surface 5 includes a first metal layer 511 and a second metal layer 512, the dielectric layer may be a plurality of non-metal support members disposed between the first metal layer 511 and the second metal layer 512.

As described above, a quantity of phase shifters 6 of the frequency selective surface 5 and a quantity of transmission line structures 71 in the feeding network 7 are not limited, and may be one or more. When an antenna includes a plurality of radiators, one phase shifter 6 and a plurality of transmission line structures 71 may be disposed in the frequency selective surface structure 200. One phase shifter 6 may be electrically connected to the plurality of transmission line structures 71, and then is electrically connected to the radiators in the antenna through the transmission line structures 71. Alternatively, a plurality of phase shifters 6 may be disposed. Each phase shifter 6 is electrically connected to a part of the transmission line structures 71, and then is electrically connected to a part of the radiators in the antenna through the transmission line structures 71. This is not limited in this disclosure.

For ease of understanding, the following lists two scenarios for illustration.

As shown in FIG. 9 to FIG. 10b, a dual-polarized first antenna 1 in the antenna system 100 is used as an example. In the figure, four radiators 10 arranged along the second direction y are drawn, and the four radiators 10 form one column of radiators 10. As shown in FIG. 9, in an example scenario, the frequency selective surface structure 200 includes two phase shifters 6. The two phase shifters 6 are distributed on two sides of one column of radiators in a third direction x, and each phase shifter 6 is electrically connected to the four radiators 10 respectively through four transmission line structures 71, to adjust phases of the four radiators 10. As shown in FIG. 10a, in another example scenario, the frequency selective surface structure 200 includes four phase shifters 6, and two phase shifters 6 are distributed on two sides of one column of radiators 10 in a third direction x. In two phase shifters 6 on a left side in FIG. 10a, a phase shifter 6 located above is electrically connected to two radiators 10 respectively through two transmission line structures 71, to adjust phases of the two radiators 10, and a phase shifter 6 located below is electrically connected to the other two radiators 10 respectively through two transmission line structures 71, to adjust phases of the other two radiators 10. Two phase shifters 6 on a right side in FIG. 10a are arranged symmetrically with the two phase shifters 6 on the left side. Details are not described herein again.

A person skilled in the art may understand that a connection manner between the transmission line structure 71 and the radiator is not limited. As shown in FIG. 10b, as an example, the transmission line structure 71 is electrically connected to the radiator 10 through a feeder 72, one terminal of the feeder is connected to the transmission line structure 71, and the other terminal is connected to the radiator 10. A specific form of the feeder is not limited, for example, may be a conductive structure such as a cable, a conductive member, or a metal via on a printed circuit board.

A person skilled in the art may understand that the two scenarios in FIG. 9 to FIG. 10b are merely examples, and do not constitute a specific limitation on this disclosure.

A person skilled in the art may understand that a type and a specific structure of the phase shifter 6 are not limited in this disclosure. For example, the phase shifter 6 may be a physical mechanical phase shifter, an electronic solid-state phase shifter, a liquid crystal phase shifter, or a switch switching phase shifter. However, because a size of a part of the metal area 513 at the metal layer 51 is limited, to prevent the phase shifter 6 from blocking the antenna signal, a miniaturized phase shifter 6 may be used as much as possible, and the phase shifter 6 may have some connection structures for mounting on the metal layer 51. The following describe, with reference to the accompanying drawings, an example structure that may be used by the phase shifter 6.

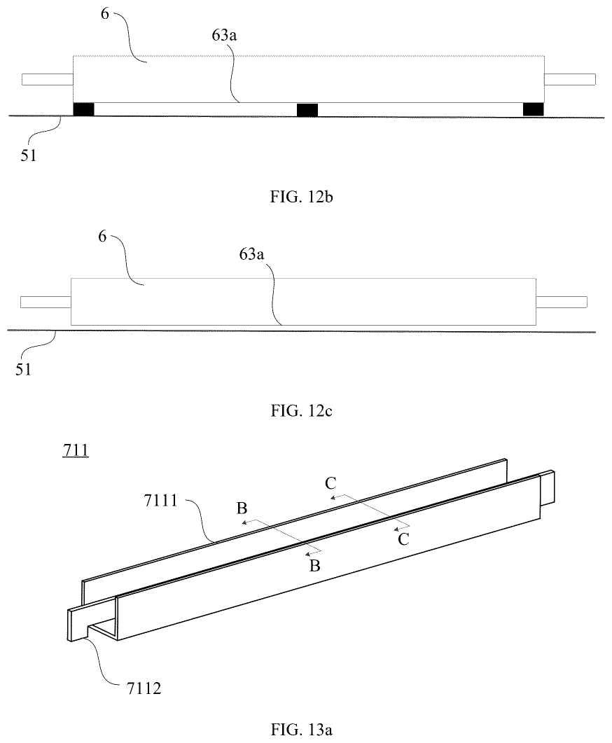

FIG. 11a is a diagram of a structure of a phase shifter in a frequency selective surface structure according to an embodiment of this disclosure. FIG. 11b is a diagram of a structure of another embodiment of a phase shifter in a frequency selective surface structure according to an embodiment of this disclosure. FIG. 12a to FIG. 12c are diagrams of connections between a phase shifter and a metal layer in a frequency selective surface structure according to an embodiment of this disclosure.

As shown in FIG. 11a and FIG. 11b, as an example, a phase shifter 6 includes an external conductor 63, a fixed dielectric 64, a sliding dielectric 65, and at least one signal-line winding 66. An accommodation cavity is formed in the external conductor 63, and the fixed dielectric 64, the sliding dielectric 65, and the at least one signal-line winding 66 are accommodated in the accommodation cavity. The fixed dielectric 64 is fastened to the external conductor 63, and the sliding dielectric 65 is located between the fixed dielectric 64 and the external conductor 63 and is slidably connected to the fixed dielectric 64. Each signal-line winding 66 is wound around and fastened to the fixed dielectric 64, each signal-line winding 66 is located between the fixed dielectric 64 and the sliding dielectric 65, and the phase shifter 6 is electrically connected to the feeding network 7 through each signal-line winding 66. At least a part of the external conductor 63 is set to be of a planar structure, and the phase shifter 6 is fastened to the metal layer 51 through the planar structure.

The external conductor 63 is a housing of the phase shifter 6, and a material of the external conductor 63 is metal. As an example, the external conductor 63 is electrically connected to the metal layer 51, to implement grounding of the phase shifter 6. The signal-line winding 66 is electrically connected to the feeding network 7, and then is electrically connected to a radiator of an antenna through a transmission line structure 71 in the feeding network 7. A specific quantity of signal-line windings 66 is not limited. In an example scenario, one phase shifter 6 is electrically connected to four radiators. In this case, four signal-line windings 66 are correspondingly disposed in the phase shifter 6, and each signal-line winding 66 is correspondingly connected to one radiator through the transmission line structure 71.

When one phase shifter 6 is electrically connected to a plurality of radiators, the plurality of radiators electrically connected to the phase shifter 6 may be radiators of antennas on a same band, or may be radiators of antennas on different bands. For example, one phase shifter 6 may be electrically connected to both a radiator 10 of a first antenna 1 and a radiator 30 of a third antenna 3. This is not limited in this disclosure.

One phase shifter 6 may have a plurality of input terminals 61 and a plurality of output terminals 62. This is not limited in this disclosure. As an example, the phase shifter 6 has a plurality of signal-line windings 66, the plurality of signal-line windings 66 form at least one group of signal-line windings, and each group of signal-line windings includes at least one signal-line winding 66. In each group of signal-line windings, the signal-line windings 66 are connected at one terminal to form one input terminal 61 of the phase shifter 6, the other terminal of each signal-line winding 66 forms at least one output terminal 62 of the phase shifter 6, and each output terminal 62 of the at least one output terminal 62 is electrically connected to a corresponding transmission line structure 71. A quantity of signal-line winding groups in the phase shifter 6 and a quantity of signal-line windings 66 in each group of signal-line windings are not limited. For example, one phase shifter 6 may include one, two, three, or more groups of signal-line windings, each group of signal-line windings may include one, two, three, or more signal-line windings 66, and each group of signal-line windings may correspond to a radiator of an antenna on one band.

For example, in a scenario shown in FIG. 9, a group of signal-line windings is disposed in each phase shifter 6, the group of signal-line windings includes four signal-line windings 66, the four signal-line windings 66 are connected at one terminal to form the input terminal 61 of the phase shifter 6, and the four signal-line windings 66 respectively form, at another terminal, four output terminals 62 of the phase shifter 6 (two output terminals 62 are integrated into a same outlet of the phase shifter 6, and therefore, three output terminals 62 are marked in the figure). Each of the four output terminals 62 is electrically connected to one transmission line structure 71, and is electrically connected to a corresponding radiator. The input terminal 61 of the phase shifter 6 is also electrically connected to one transmission line structure 71. The transmission line structure 71 may be connected to another component in the antenna system 100 or a base station 300, for example, a radio frequency module or a power supply circuit. As an example, the input terminal 61 of the phase shifter 6 is electrically connected to a radio frequency module 8 of the base station 300 through the transmission line structure 71.

In another example scenario, the phase shifter 6 may alternatively include two groups of signal-line windings. One of the two groups of signal-line windings is electrically connected to a plurality of radiators 10 of the first antenna 1 through a plurality of signal-line windings 66, and the other group of signal-line windings is electrically connected to a plurality of radiators 30 of the third antenna 3 through a plurality of signal-line windings 66. All signal-line windings 66 in one group of signal-line windings electrically connected to the first antenna 1 are connected at one terminal to form one input terminal 61 of the phase shifter 6, and the signal-line windings 66 in the other group of signal-line windings electrically connected to the third antenna 3 are connected at one terminal to form another input terminal 61 of the phase shifter 6. The two input terminals 61 of the phase shifter 6 may be electrically connected to different radio frequency modules or different ports of a same radio frequency module through different transmission line structures.

Further, the fixed dielectric 64 is fastened relative to the external conductor 63, the signal-line winding 66 is fastened to the fixed dielectric 64, and the sliding dielectric 65 covers a surface of the signal-line winding 66 and may slide on a surface of the signal-line winding 66. A principle of adjusting a phase of a radiator by the phase shifter 6 is: changing a position of the sliding dielectric 65 may change a range that is of each signal-line winding 66 and that is covered by the sliding dielectric 65. A part that is of the signal-line winding 66 and that is not covered by the sliding dielectric 65 is exposed to air. An electrical length of the signal-line winding 66 changes, thereby changing a phase shift amount of a radiator corresponding to each signal-line winding 66.

When the phase shifter 6 is of the foregoing structure, the plurality of signal-line windings are jointly wound around the fixed dielectric 64, and different signal-line windings 66 may be set to be of a bent structure in the phase shifter 6, so that the plurality of signal-line windings 66 are concentrated in a small area. Therefore, the phase shifter 6 has a compact structure and a small size. The fixed dielectric 64 and the sliding dielectric 65 of the phase shifter 6 may alternatively be made of a material with a high dielectric constant, to further reduce a volume of the phase shifter 6. Alternatively, a large quantity of phase shifters 6 may be arranged in the frequency selective surface structure 200, and a small quantity of signal-line windings 66 (for example, one or two signal-line windings 66) are disposed in each phase shifter 6, which can also reduce a volume of the phase shifter 6.

A person skilled in the art may understand that a specific shape of the external conductor 63 is not limited. For ease of description, a part that is of the phase shifter 6 and that is connected to the metal layer 51 is defined as a bottom 63a of the external conductor 63. As shown in FIG. 11a, as an example, the bottom 63a is entirely set to be of a planar structure, so that the external conductor 63 entirely forms a closed structure; and the fixed dielectric 64 may be fastened to the bottom 63a. As shown in FIG. 11b, in an alternative implementation, an opening may be further disposed at the bottom 63a of the external conductor 63, so that the external conductor 63 forms a semi-closed structure having an opening; and the fixed dielectric 64 may be fastened to side walls on two sides of the opening. The bottom 63a of the external conductor 63 is fastened to the metal layer 51, for example, may be fastened to a grid line in the metal grille 5131. When a width d1 of the phase shifter 6 is less than or equal to a width w of the grid line (as shown in FIG. 9 to FIG. 10a), a projection of the phase shifter 6 onto the metal layer 51 along the first direction z is entirely located in the metal area 513, and does not block an antenna beam.

A person skilled in the art may understand that, when the phase shifter 6 is fastened to the metal layer 51 and the external conductor 63 is electrically connected to the metal layer 51, a specific manner of fastening the phase shifter 6 to the metal layer 51 is not limited. The phase shifter 6 may be directly fastened to the metal layer 51, or may be indirectly fastened to the metal layer 51. As shown in FIG. 12a, as an example, the phase shifter 6 is direct-current connected to the metal layer 51, and the bottom 63a of the external conductor 63 is entirely in contact with the metal layer 51. For example, the external conductor 63 may be entirely welded to the metal layer 51. In this way, a connection is more secure. As shown in FIG. 12b, in an alternative implementation, the phase shifter 6 may alternatively be segmented direct-current connected to the metal layer 51, and a part of the bottom 63a of the external conductor 63 is in contact with the metal layer 51. For example, several welding points may be spaced apart along the grid line in the metal grille 5131, and the phase shifter 6 is welded to the metal layer 51 at a position of the welding point. An operation is simple, and manpower can be saved. As shown in FIG. 12c, in another alternative embodiment, the phase shifter 6 is coupled to the metal layer 51. The phase shifter 6 is not in direct contact with the metal layer 51, and an insulated support member such as a plastic snap-fit may be disposed between the phase shifter 6 and the metal layer 51. The phase shifter 6 is fastened to the metal layer 51 through an insulated support member, and may be electrically connected to the metal layer 51 through current coupling, or the like. In addition to the foregoing three connection manners, the phase shifter 6 may alternatively be fastened to the metal layer 51 in another manner and electrically connected to the metal layer 51. Examples are not listed one by one herein.

A person skilled in the art may understand that a specific type and structure of the transmission line structure 71 in the feeding network 7 are not limited, for example, may be a microstrip or a coaxial cable. The following describes several example structures with reference to the accompanying drawings.

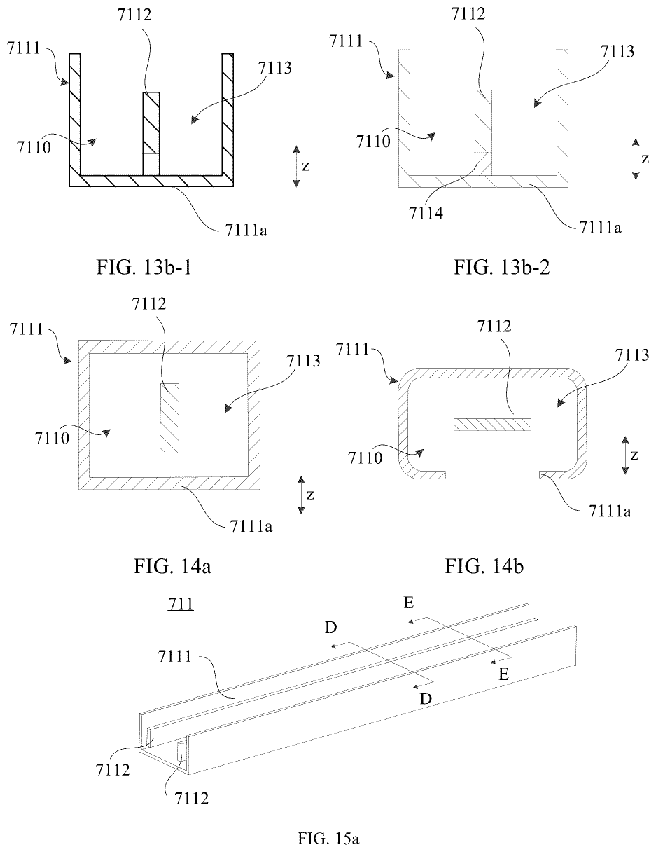

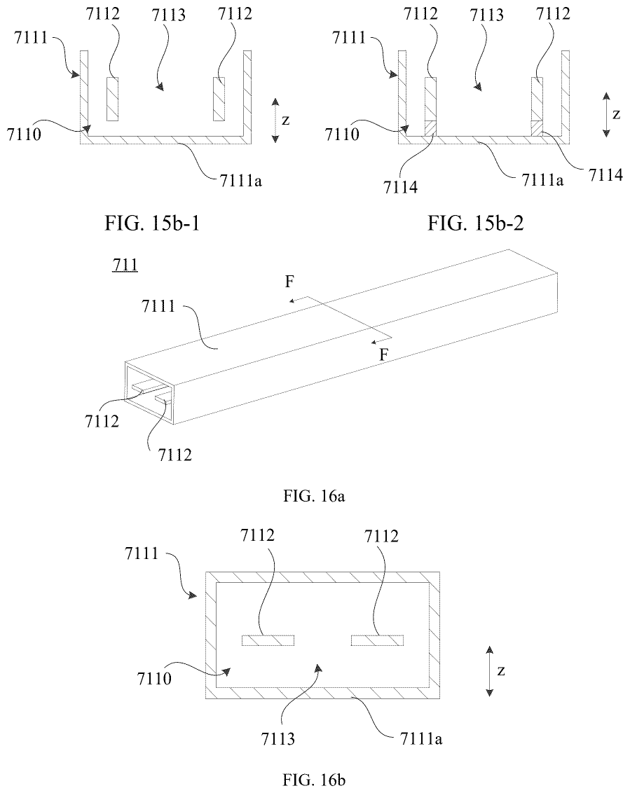

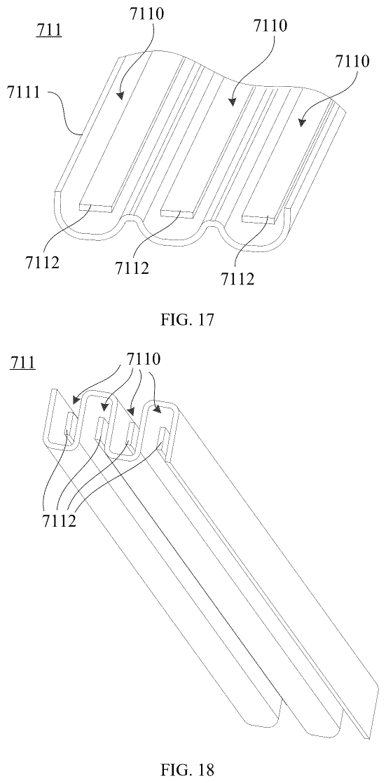

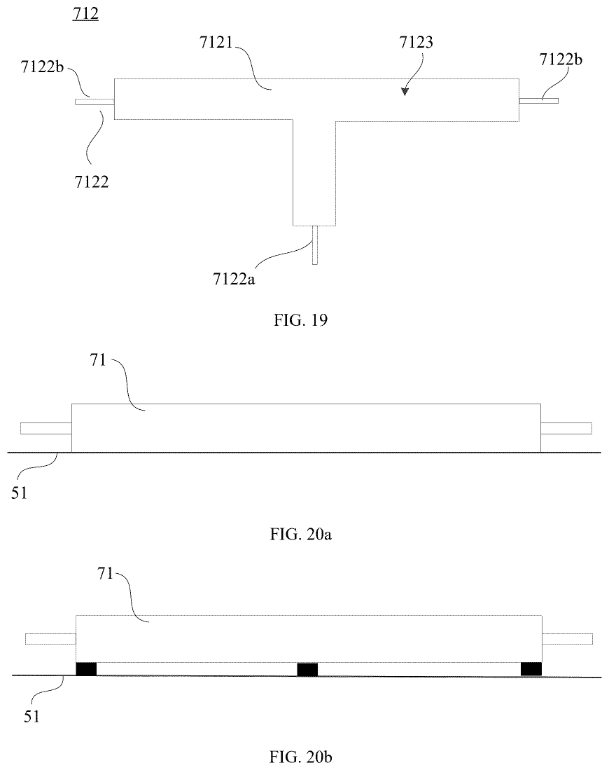

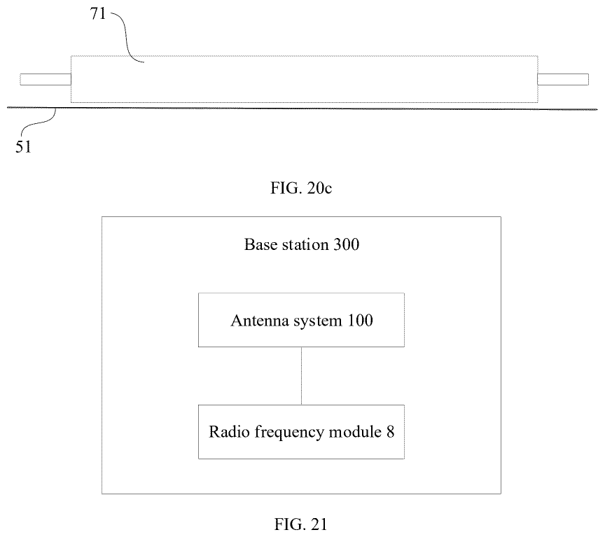

FIG. 13a to FIG. 13b-2 are diagrams of structures of a first embodiment of a first transmission line structure in a frequency selective surface structure according to an embodiment of this disclosure, where FIG. 13b-1 is a sectional view in a direction B-B in FIG. 13a, and FIG. 13b-2 is a sectional view in a direction C-C in FIG. 13a. FIG. 14a is a diagram of a structure of a second embodiment of a first transmission line structure in a frequency selective surface structure according to an embodiment of this disclosure. FIG. 14b is a diagram of a structure of a third embodiment of a first transmission line structure in a frequency selective surface structure according to an embodiment of this disclosure. FIG. 15a to FIG. 15b-2 are diagrams of structures of a fourth embodiment of a first transmission line structure in a frequency selective surface structure according to an embodiment of this disclosure, where FIG. 15b-1 is a sectional view in a direction D-D in FIG. 15a, and FIG. 15b-2 is a sectional view in a direction E-E in FIG. 15a. FIG. 16a and FIG. 16b are diagrams of structures of a fifth embodiment of a first transmission line structure in a frequency selective surface structure according to an embodiment of this disclosure, where FIG. 16b is a sectional view in a direction F-F in FIG. 16a. FIG. 17 is a diagram of a structure of a sixth embodiment of a first transmission line structure in a frequency selective surface structure according to an embodiment of this disclosure. FIG. 18 is a diagram of a structure of a seventh embodiment of a first transmission line structure in a frequency selective surface structure according to an embodiment of this disclosure. FIG. 19 is a diagram of a structure of a power divider in a frequency selective surface structure according to an embodiment of this disclosure. FIG. 20a to FIG. 20c are diagrams of connections between a transmission line structure and a metal layer in a frequency selective surface structure according to an embodiment of this disclosure.

As shown in FIG. 13a to FIG. 18, as an example, a plurality of transmission line structures 71 in a feeding network 7 may include a first transmission line structure 711. The first transmission line structure 711 is entirely of a linear structure, and extends along a grid line in a metal grille 5131 at the metal layer 51. When a width d2 of the first transmission line structure 711 is less than a width w of the grid line (as shown in FIG. 9 to FIG. 10b), a projection of the first transmission line structure 711 onto the metal layer 51 along a first direction z is entirely located in a metal area 513, to avoid blocking an antenna beam.

As an example, the first transmission line structure 711 includes an external conductor 7111 and a core 7112, the core 7112 is wrapped in a cavity 7110 inside the external conductor 7111, and there is an airgap 7113 between the core 7112 and the external conductor 7111. The external conductor 7111 is a housing of the first transmission line structure 711, the core 7112 is configured to transmit a signal, and the airgap 7113 indicates that a medium between the external conductor and the core 7112 is air. In this structure, the core 7112 is entirely suspended in the cavity 7110 of the external conductor 7111, and the core 7112 is surrounded by air in the cavity 7110. A dielectric constant of the air is small, so that a transmission loss of the first transmission line structure 711 can be reduced. As an example, the first transmission line structure 711 further includes a plurality of support members 7114 disposed between the external conductor 7111 and the core 7112, the plurality of support members 7114 are spaced apart along an extension direction of the core 7112, and the core 7112 is fastened to the external conductor 7111 through the plurality of support members 7114. A specific form of the support member 7114 is not limited. For example, the support member 7114 may be a dielectric mechanical part.

Further, at least a part of the external conductor 7111 is set to be of a planar structure, and the first transmission line structure 711 is fastened to the metal layer 51 through the planar structure. As an example, the external conductor 7111 is further electrically connected to the metal layer 51, to implement grounding of the first transmission line structure 711.

A person skilled in the art may understand that a shape of the external conductor 7111 and a shape of the core 7112 are not limited. For ease of description, a part that is of the external conductor and that is connected to the metal layer 51 is defined as a bottom 7111a of the external conductor. As shown in FIG. 13a to FIG. 13b-2, FIG. 15a to FIG. 15b-2, and FIG. 17, as an example, the external conductor 7111 is of a semi-closed structure, and an opening is disposed at a position opposite to the bottom 7111a in the first direction z. As shown in FIG. 14b, in an alternative implementation, an opening may also be disposed at the bottom 7111a of the external conductor 7111, so that the external conductor 7111 forms a semi-closed structure. As shown in FIG. 14a, FIG. 16a, and FIG. 16b, in another alternative embodiment, the external conductor 7111 may alternatively be of a closed structure.

As an example, the core 7112 is entirely set to be of a linear structure with a rectangular cross section. As shown in FIG. 13b-1, FIG. 13b-2, FIG. 14a, FIG. 15b-1, FIG. 15b-2, and FIG. 18, as an example, a long side of a rectangle is vertically disposed. In other words, the long side of the rectangle is perpendicular to the bottom 7111a of the external conductor 7111. As shown in FIG. 14b, FIG. 16a, FIG. 16b, and FIG. 17, in an alternative implementation, a long side of a rectangle is horizontally disposed. In other words, the long side of the rectangle is parallel to the bottom 7111a of the external conductor 7111.

A person skilled in the art may understand that, in the first transmission line structure 711, the external conductor 7111 may have one or more cavities 7110, or may be provided with one or more cores 7112. This is not limited. As shown in FIG. 13a to FIG. 14b, as an example, the first transmission line structure 711 includes one core 7112, the external conductor 7111 has one cavity 7110, and the one core 7112 is disposed in the cavity 7110. As shown in FIG. 15a to FIG. 16b, as an example, the first transmission line structure 711 includes two cores 7112, the external conductor 7111 has one cavity 7110, the two cores 7112 are spaced apart in a same cavity 7110, and there is an airgap between adjacent cores 7112. As shown in FIG. 17 and FIG. 18, as an example, the first transmission line structure 711 includes three cores 7112, the external conductor 7111 has three cavities 7110, and the three cores 7112 are respectively located in different cavities 7110. The three cavities 7110 may be connected to each other (as shown in FIG. 17), or may be independent of each other (as shown in FIG. 18). This is not limited in this disclosure.

As shown in FIG. 19, as an example, the plurality of transmission line structures 71 in the feeding network 7 may further include a second transmission line structure, and the second transmission line structure is configured as a power divider 712. The power divider 712 includes a conductive housing 7121 and an electrochemical cell 7122, the electrochemical cell 7122 is wrapped in a cavity 7110 inside the conductive housing 7121, and there is an airgap 7123 between the electrochemical cell 7122 and the conductive housing 7121. At least a part of the conductive housing 7121 is set to be of a planar structure, and the power divider 712 is fastened to the metal layer 51 through the planar structure. The conductive housing 7121 of the power divider 712 has a same function as the external conductor in the first transmission line structure 711, the electrochemical cell 7122 of the power divider 712 has a same function as the core 7112 of the first transmission line structure 711, and there is an airgap 7123 between the electrochemical cell 7122 and the conductive housing 7121. That is, the electrochemical cell 7122 is suspended in the conductive housing 7121 and surrounded by air, to reduce a transmission loss of the power divider 712.

As an example, the power divider 712 further includes a plurality of support members disposed between the conductive housing 7121 and the electrochemical cell 7122, the plurality of support members are spaced apart, and the electrochemical cell 7122 is partially supported in the conductive housing 7121. A specific form of the support member is not limited. For example, the support member may be a dielectric mechanical part.

Different from the first transmission line structure, the electrochemical cell 7122 has one input terminal 7122a and a plurality of output terminals 7122b. A specific quantity of output terminals is not limited. As an example, the electrochemical cell 7122 has one input terminal 7122a and two output terminals 7122b. A signal is input from the input terminal 7122a to the power divider 712, is divided into two paths inside the power divider 712, and is respectively output from the two output terminals 7122b. The conductive housing 7121 may be designed to be of a “T-shaped” structure with three openings. The input terminal 7122a and the output terminal 7122b of the electrochemical cell 7122 respectively extend out of the conductive housing 7121 through the three openings, and are electrically connected to another component. As an example, the input terminal 7122a of the electrochemical cell 7122 may be connected to the phase shifter 6, and the output terminal 7122b may be connected to another transmission line structure 71. Alternatively, both the input terminal 7122a and the output terminal 7122b of the electrochemical cell 7122 may alternatively be connected to another transmission line structure, or the like. This is not limited in this disclosure.

More generally, it is understood that, the first transmission line structure 711 is a linear structure with two ports. One of the two ports serves as an input terminal, and the other serves as an output terminal. The power divider 712 may be considered as combining a plurality of first transmission line structures 711 to form a transmission line structure 71 with more than two ports. One or more of the more than two ports may serve as an input terminal 7122a, and the other ports serve as an output terminal 7122b. This is not limited in this disclosure. In an example scenario, the electrochemical cell 7122 of the power divider 712 may alternatively have one output terminal 7122b and a plurality of input terminals 7122a, and may combine a plurality of paths of signals into one path.

A person skilled in the art may understand that the transmission line structure 71 is fastened to the metal layer 51, and may be grounded through the metal layer 51 (for example, the external conductor in the first transmission line structure 711 is electrically connected to the metal layer 51, and the conductive housing 7121 of the power divider 712 is electrically connected to the metal layer 51). A specific manner of fastening the transmission line structure 71 to the metal layer 51 is not limited. The transmission line structure 71 may be directly fastened to the metal layer 51, or may be indirectly fastened to the metal layer 51.

As shown in FIG. 20a, as an example, the transmission line structure 71 is direct-current connected to the metal layer 51. As shown in FIG. 20b, as an example, the transmission line structure 71 may alternatively be segmented direct-current connected to the metal layer 51. As shown in FIG. 20c, as an example, the transmission line structure 71 is coupled to the metal layer 51. Definitions of a direct-current connection, a segmented direct-current connection, and a coupling connection are the same as the foregoing connection manner between the phase shifter 6 and the metal layer 51. Details are not described herein again.

The foregoing describes functions and structures of parts of the antenna system 100 and the frequency selective surface structure 200 in this disclosure. A person skilled in the art may understand that a forming manner of the antenna system 100 is not limited. For example, parts of the antenna system 100 may be produced separately, and then the parts are assembled. In one implementation, the antenna system 100 is formed on a printed circuit board. In an embodiment, the printed circuit board has a metal structure and a non-metal structure. For example, the printed circuit board may include a plurality of metal layers that are stacked and a plurality of dielectric layers disposed between adjacent metal layers. The metal layers may be connected through a metal via that penetrates through the dielectric layers. The metal layers and the metal via form the metal structure of the printed circuit board, and the plurality of dielectrics form a dielectric structure of the printed circuit board. As an example, at least a part of the metal structure forms parts (that is, the foregoing parts are directly processed and formed on the metal structure of the printed circuit board) of a metal material such as a ground 4, a radiator of each antenna, and a metal layer 51 of a frequency selective surface 5 in the antenna system 100. At least a part of a dielectric structure of the printed circuit board forms a non-metal part (that is, the dielectric layer is directly processed and formed in the dielectric structure of the printed circuit board) such as a dielectric layer of the frequency selective surface structure 200. In another alternative embodiment, the antenna system 100 may alternatively be processed in another manner. Examples are not listed one by one herein.

FIG. 21 is a diagram of a structure of a base station according to an embodiment of this disclosure.

As shown in FIG. 21, this disclosure further provides a base station 300, including an antenna system 100 and a radio frequency module 8 connected to the antenna system 100. The base station 300 provided in this disclosure may be a device configured to communicate with a terminal device, including a base transceiver station (BTS) in a global system for mobile communications (GSM) or a code division multiple access (CDMA) system; or may be a NodeB (NB) in a wideband code division multiple access (wideband code division multiple access, WCDMA) system; or may be an evolved NodeB (eNB, or eNodeB) in an LTE system; or may be a radio controller in a cloud radio access network (CRAN) scenario. Alternatively, the base station 300 may include a relay station, an access point, a vehicle-mounted device, a wearable device, a base station in a future 5G network, a base station in a future evolved public land mobile network (PLMN), or the like. This is not limited in this embodiment of this disclosure. Antennas on a plurality of bands may be combined in the base station 300, and the base station 300 has high overall integration, a wide signal coverage area, and a small signal coverage hole.

The radio frequency module 8 may complete conversion between an air radio frequency channel and a baseband digital channel, and functions such as amplification, receiving, and sending of the radio frequency channel. A specific type of the radio frequency module 8 is not limited. In addition to the radio frequency module 8, the base station 300 may further include another component, for example, may include a power supply circuit that supplies power to the antenna. This is not limited in this disclosure.

A person skilled in the art can make various modifications and variations to this disclosure without departing from the spirit and scope of this disclosure. This disclosure is intended to cover these modifications and variations of this disclosure provided that they fall within the scope of protection defined by the following claims and their equivalent technologies.

1. A frequency selective surface structure, comprising:
a frequency selective surface including a metal layer;
a feeding network; and
a phase shifter electrically connected to the feeding network, wherein the phase shifter and the feeding network are integrated into the metal layer of the frequency selective surface.

2. The frequency selective surface structure according to claim 1, wherein the metal layer has a metal area, a hollow area is enclosed in the metal area, the feeding network and the phase shifter are integrated into the metal area, a projection of the feeding network and the phase shifter onto the metal layer along a first direction is entirely located in the metal area, and the first direction is perpendicular to a plane on which the metal layer is located.

3. The frequency selective surface structure according to claim 2, wherein the metal layer comprises a metal grille, the metal grille forms the metal area, and space enclosed by all grids of the metal grille jointly forms the hollow area.

4. The frequency selective surface structure according to claim 2, wherein the metal layer comprises a metal grille and a plurality of metal patches, the plurality of metal patches are correspondingly disposed in a plurality of grids of the metal grille, the metal grille and the metal patch form the metal area, and a gap between the metal patch and the metal grille forms the hollow area.

5. The frequency selective surface structure according to claim 2, wherein the frequency selective surface comprises a plurality of metal layers that are stacked in the first direction and that are disposed in parallel with each other, the feeding network and the phase shifter are integrated into at least one of the plurality of metal layers, and the first direction is perpendicular to the plane on which the metal layer is located.

6. The frequency selective surface structure according to claim 5, wherein the plurality of metal layers comprise two metal layers, each of the two metal layers comprises two surfaces facing away from each other in the first direction, and the feeding network and the phase shifter are integrated on any one or more surfaces of the two metal layers.

7. The frequency selective surface structure according to claim 1, wherein the feeding network comprises a plurality of transmission line structures; and
the frequency selective surface structure comprises one phase shifter, and the phase shifter is electrically connected to all of the plurality of transmission line structures; or
the frequency selective surface structure comprises a plurality of phase shifters, and each of the plurality of phase shifters is electrically connected to a part of the plurality of transmission line structures.

8. The frequency selective surface structure according to claim 7, wherein the phase shifter comprises an external conductor, a fixed dielectric, a sliding dielectric, and at least one signal-line winding, an accommodation cavity is formed in the external conductor, and the fixed dielectric, the sliding dielectric, and the at least one signal-line winding are all accommodated in the accommodation cavity;
the fixed dielectric is fastened to the external conductor, the sliding dielectric is located between the fixed dielectric and the external conductor and is slidably connected to the fixed dielectric, each of the at least one signal-line winding is wound around and fastened to the fixed dielectric, each signal-line winding is located between the fixed dielectric and the sliding dielectric, and the phase shifter is electrically connected to the feeding network through each signal-line winding; and
at least a part of the external conductor is set to be of a planar structure, and the phase shifter is fastened to the metal layer through the planar structure.

9. The frequency selective surface structure according to claim 8, wherein the at least one signal-line winding is a plurality of signal-line windings forming at least one group of signal-line windings, and each of the at least one group of signal-line windings comprises at least one signal-line winding; and
the at least one signal-line winding in each group of signal-line windings is one signal-line winding or at least two signal-line windings, one terminal of the one signal-line winding forms one input terminal of the phase shifter or the at least two signal-line windings are connected at one terminal to form one input terminal of the phase shifter, the other terminal of the at least one signal-line winding forms at least one output terminal of the phase shifter, and each of the at least one output terminal is electrically connected to a corresponding transmission line structure.

10. The frequency selective surface structure according to claim 7, wherein the plurality of transmission line structures comprise at least one first transmission line structure, each of the at least one first transmission line structure comprises an external conductor and a core, the core is wrapped in a cavity inside the external conductor, and there is an airgap between the core and the external conductor; and
at least a part of the external conductor is set to be of a planar structure, and the first transmission line structure is fastened to the metal layer through the planar structure.

11. The frequency selective surface structure according to claim 10, wherein the first transmission line structure further comprises a plurality of support members disposed between the external conductor and the core, the plurality of support members are spaced apart along an extension direction of the core, and the core is fastened to the external conductor through the plurality of support members.

12. The frequency selective surface structure according to claim 10, wherein the first transmission line structure comprises a plurality of cores spaced apart; and
the external conductor has:
one cavity for the plurality of cores located therein; or
a plurality of cavities that communicate with each other, the plurality of cavities are in one-to-one correspondence with the plurality of cores, and each core is located in a corresponding cavity.

13. The frequency selective surface structure according to claim 710, wherein
the plurality of transmission line structures comprise at least one second transmission line structure, each of the at least one second transmission line structure is configured as a power divider, the power divider comprises a conductive housing and an electrochemical cell, the electrochemical cell is wrapped in a cavity inside the conductive housing, there is an airgap between the electrochemical cell and the conductive housing, the electrochemical cell has one input terminal and a plurality of output terminals, and the input terminal of the electrochemical cell is electrically connected to the phase shifter; and
at least a part of the conductive housing is set to be of a planar structure, and the second transmission line structure is fastened to the metal layer through the planar structure.

14. The frequency selective surface structure according to claim 13, wherein
when the phase shifter comprises an external conductor, the external conductor of the phase shifter is electrically connected to the metal layer;
when the feeding network comprises the plurality of transmission line structures, the plurality of transmission line structures comprise the at least one first transmission line structure, and each of the at least one first transmission line structure comprises the external conductor, the external conductor of each first transmission line structure is electrically connected to the metal layer;
when the feeding network comprises the plurality of transmission line structures, the plurality of transmission line structures comprise the at least one second transmission line structure, and each of the at least one second transmission line structure comprises the conductive housing, the conductive housing of each second transmission line structure is electrically connected to the metal layer; and
electrical connection manner is any one of the following: a coupling connection, a direct-current connection, or a segmented direct-current connection.

15. The frequency selective surface structure according to claim 1, wherein the frequency selective surface structure further comprises a dielectric layer, and the metal layer is mounted at the dielectric layer.

16. An antenna system, comprising:
a plurality of antennas that are stacked in a first direction;
a ground disposed on one side of the plurality of antennas in the first direction; and
a plurality of feeding networks configured to feed the plurality of antennas;
a frequency selective surface structure including a frequency selective surface, a feeding network, and a phase shifter, wherein;
the frequency selective surface comprises a metal layer,
the phase shifter is electrically connected to the feeding network, and
the phase shifter and the feeding network are integrated into the metal layer of the frequency selective surface; and wherein:
the frequency selective surface structure is disposed between adjacent antennas that are stacked in the plurality of antennas, and
a feeding network of the frequency selective surface structure forms a feeding network of at least one antenna away from the ground in the adjacent antennas that are stacked.

17. The antenna system according to claim 16, wherein the plurality of antennas comprise a first antenna and a second antenna that are stacked in the first direction, the ground is disposed on a side that is of the second antenna and that is away from the first antenna, and the frequency selective surface structure is disposed between the first antenna and the second antenna; and
the first antenna and the second antenna each comprise a plurality of radiators distributed in an array, and at least a part of the feeding network of the frequency selective surface structure forms the feeding network of the first antenna, and is electrically connected to a plurality of radiators of the first antenna, to feed the plurality of radiators of the first antenna.

18. The antenna system according to claim 17, wherein when the frequency selective surface structure comprises two metal layers, the feeding network and a phase shifter of the frequency selective surface structure are integrated into a metal layer away from the second antenna in the two metal layers.

19. The antenna system according to claim 18, wherein the plurality of radiators of the first antenna form at least one column of radiators, and each of the at least one column of radiators comprises at least two radiators spaced apart along a second direction; and
when the feeding network of the frequency selective surface structure comprises a plurality of transmission line structures, the transmission line structures are symmetrically distributed on two sides of each column of radiators in a third direction, a phase shifters are symmetrically distributed on the two sides of each column of radiators in the third direction, and the first direction, the second direction, and the third direction are perpendicular to each other.

20. The antenna system according to claim 1719, wherein the plurality of antennas further comprise a third antenna, the third antenna is disposed on a side that is of the frequency selective surface structure and that is away from the ground, the third antenna comprises a plurality of radiators distributed in an array, and the plurality of radiators of the third antenna and the plurality of radiators of the first antenna are alternately arranged on a plane perpendicular to the first direction; and
at least a part of the feeding network of the frequency selective surface structure forms a feeding network of the third antenna, and is electrically connected to the plurality of radiators of the third antenna, to feed the plurality of radiators of the third antenna.

21. The antenna system according to claim 20, wherein the plurality of radiators of the third antenna form at least one column of radiators, and each of the at least one column of radiators comprises at least two radiators spaced apart along the second direction; and
when the feeding network of the frequency selective surface structure comprises the plurality of transmission line structures, the transmission line structures are symmetrically distributed on the two sides of each column of radiators in the third direction, the phase shifters are symmetrically distributed on the two sides of each column of radiators in the third direction, and the first direction, the second direction, and the third direction are perpendicular to each other.

22. The antenna system according to claim 20, wherein when the frequency selective surface structure comprises the two metal layers, the phase shifter and the feeding network are integrated into each of the two metal layers, a part that is of the feeding network of the frequency selective surface and that forms the feeding network of the first antenna is integrated into either of the two metal layers, and a part that is of the feeding network of the frequency selective surface and that forms the feeding network of the third antenna is integrated into the other one of the two metal layers.

23. The antenna system according to claim 16, wherein the antenna system is formed on a printed circuit board, the printed circuit board comprises a metal structure and a dielectric structure, at least a part of the metal structure forms the ground, a plurality of radiators of each of the plurality of antennas, and the metal layer of the frequency selective surface structure, and when the frequency selective surface structure further comprises a dielectric layer, at least a part of the dielectric structure of the printed circuit board forms the dielectric layer of the frequency selective surface structure.

24. A base station, comprising:
an antenna system including a ground, a plurality of antennas that are stacked in a first direction, and a frequency selective surface structure, wherein the frequency selective surface structure comprises a frequency selective surface, a feeding network, and a phase shifter, wherein the frequency selective surface comprises a metal layer, the phase shifter is electrically connected to the feeding network, and the phase shifter and the feeding network are integrated into the metal layer of the frequency selective surface; and
a radio frequency module connected to the antenna system, wherein a plurality of feeding networks configured to feed the plurality of antennas, wherein the ground is disposed on one side of the plurality of antennas in the first direction,
wherein the frequency selective surface structure is disposed between adjacent antennas that are stacked in the plurality of antennas, and a feeding network of the frequency selective surface structure forms a feeding network of at least one antenna away from the ground in the adjacent antennas that are stacked.
